(19) United States
(12) Patent Application Publication
(10) Pub. No.: US 2026/0113458 A1
(43) Pub. Date: Apr. 23, 2026

(54) MOTION TEMPLATE-MATCHING-BASED MOTION REFINEMENT

(71) Applicant: Alibaba (China) Co., Ltd., Hangzhou (CN)

(72) Inventors: Jie CHEN, Beijing (CN); Ru-ling LIAO, Sunnyvale, CA (US); Xinwei LI, Beijing (CN); Yan YE, San Diego, CA (US)

(21) Appl. No.: 19/337,353

(22) Filed: Sep. 23, 2025

Related U.S. Application Data
(60) Provisional application No. 63/709,600, filed on Oct. 21, 2024.

(51) Int. Cl. H04N 19/137; H04N 19/176; H04N 19/70

(52) U.S. Cl. CPC H04N 19/137; H04N 19/176; H04N 19/70

(57) ABSTRACT

A method of decoding a video bitstream includes: determining a control point motion vector predictor (CPMVP) for an affine coded target block; refining the CPMVP based on a template matching (TM) cost to get a refined CPMVP; deriving the control point motion vector (CPMV) based on the refined CPMVP and a control point motion vector difference (CPMVD); and decoding the affine coded target block based on the CPMV.

### CROSS-REFERENCE TO RELATED APPLICATIONS

This application claims priority to U.S. Provisional Application No. 63/709,600, titled “MOTION TEMPLATE-MATCHING-BASED MOTION REFINEMENT,” filed on Oct. 21, 2024, which is hereby incorporated by reference in its entirety.

### TECHNICAL FIELD

The present disclosure generally relates to video processing, and more particularly, to methods and apparatuses for template-matching-based motion refinement.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard, AVS standards, specifying the specific video coding formats, are developed by standardization organizations. With more and more advanced video coding technologies being adopted in the video standards, the coding efficiency of the new video coding standards get higher and higher.

### SUMMARY

Embodiments of the present disclosure provide methods and apparatuses for motion template-matching-based motion refinement.

According to some embodiments, a method of decoding a video bitstream includes: determining a control point motion vector predictor (CPMVP) for an affine coded target block; refining the CPMVP based on a template matching (TM) cost to get a refined CPMVP; deriving the control point motion vector (CPMV) based on the refined CPMVP and a control point motion vector difference (CPMVD); and decoding the affine coded target block based on the CPMV.

According to some embodiments, a method of encoding a video bitstream includes: determining a control point motion vector predictor (CPMVP) for an affine coded target block; refining the CPMVP based on a template matching (TM) cost to get a refined CPMVP; determining a control point motion vector difference (CPMVD) based on a control point motion vector (CPMV) and the refined CPMVP; and signaling the CPMVD in a bitstream.

According to some embodiments, a method for transmitting a bitstream includes: receiving a video sequence; encoding the video sequence by: determining a control point motion vector predictor (CPMVP) for an affine coded target block; refining the CPMVP based on a template matching (TM) cost to get a refined CPMVP; and determining a control point motion vector difference (CPMVD) based on a control point motion vector (CPMV) and the refined CPMVP; and signaling a bitstream comprising the CPMVD generated based on the encoding.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 illustrates structures of an exemplary video sequence, according to some embodiments of the present disclosure.

FIG. 2 illustrates a schematic diagram of an exemplary encoder of a video coding system, according to some embodiments of the present disclosure.

FIG. 3 illustrates a block diagram of an exemplary decoder of a video coding system, according to some embodiments of the present disclosure.

FIG. 4 is a block diagram of an exemplary apparatus for encoding or decoding a video, according to some embodiments of the present disclosure.

FIG. 5 illustrates an example decoding side motion vector refinement (DMVR) process, according to some embodiments of the present disclosure.

FIG. 6 illustrates an example 3×3 square search pattern for the first pass in the MP-DMVR, according to some embodiments of the present disclosure.

FIG. 7 illustrates an example of diamond regions in the search area for the second pass in the MP-DMVR, according to some embodiments of the present disclosure.

FIG. 8 illustrates an example template matching process performed on a search area around initial MV, according to some embodiments of the present disclosure.

FIG. 9A and FIG. 9B illustrate example diamond search patterns, according to some embodiments of the present disclosure.

FIG. 10 is a flowchart of a template-based refinement process for bi-prediction coding blocks, according to some embodiments of the present disclosure.

FIG. 11A and FIG. 11B are two schematic diagrams illustrating control-points-based affine model for blocks, according to some embodiments of the present disclosure.

FIG. 12 is a schematic diagram illustrating motion vector of the center sample of each subblock of a block, according to some embodiments of the present disclosure.

FIG. 13 illustrates control point motion vector inheritance, according to some embodiments of the present disclosure.

FIG. 14A and FIG. 14B illustrate spatial neighbors for deriving affine merge and affine advanced motion vector prediction (AMVP) candidates, according to some embodiments of the present disclosure.

FIG. 15 illustrates locations of candidates position for constructed affine merge mode, according to some embodiments of the present disclosure.

FIG. 16 illustrates a first type of constructed affine merge/AMVP candidates, according to some embodiments of the present disclosure.

FIG. 17 illustrates neighboring subblocks being used for regression based affine merge candidate derivation, according to some embodiments of the present disclosure.

FIG. 18 illustrates subblock MV and pixel, according to some embodiments of the present disclosure.

FIG. 19 illustrates a template and reference samples of the template in reference pictures, according to some embodiments of the present disclosure.

FIG. 20 illustrates a template and reference samples of the template for block with subblock motion, according to some embodiments of the present disclosure.

FIG. 21 is a flowchart of a template-based reordering and template-based motion refinement process, according to some embodiments of the present disclosure.

FIG. 22 is another flowchart of a template-based reordering and template-based motion refinement process, according to some embodiments of the present disclosure.

FIG. 23A and FIG. 23B are flowcharts of template-based reordering and template-based motion refinement processes and, according to some embodiments of the present disclosure.

FIG. 24 illustrates templates of a reference block used in the AMVP candidate reordering and TM based refinement, according to some embodiments of the present disclosure.

FIG. 25 illustrates an above template and a left template for affine motion compensation, according to some embodiments of the present disclosure.

FIG. 26 illustrates MVs of sub-templates of an affine motion codec block, according to some embodiments of the present disclosure.

FIG. 27 illustrates MVs of sub-templates of an affine motion codec block, according to some embodiments of the present disclosure.

FIG. 28A illustrates an integer template matching (TM) search process, according to some embodiments of the present disclosure.

FIG. 28B illustrates a half-pixel TM search process, according to some embodiments of the present disclosure.

FIG. 29 is a flowchart of a process of an affine merge mode, according to some embodiments of the present disclosure.

FIG. 30A illustrates refining affine parameters by fixing a top-left control point motion vector (CPMV) as a base MV, according to some embodiments of the present disclosure.

FIG. 30B illustrates refining affine parameters by fixing a top-right CPMV as a base MV, according to some embodiments of the present disclosure.

FIG. 30C illustrates refining affine parameters by fixing a bottom-left CPMV as a base MV, according to some embodiments of the present disclosure.

FIG. 31A and FIG. 31B are flowcharts illustrating processes of performing base MV refinement and non-translation parameter refinement sequentially, according to some embodiments of the present disclosure.

FIG. 31C is a flowchart illustrating a process of performing base MV refinement and non-translation parameter refinement parallelly, according to some embodiments of the present disclosure.

FIG. 32 is a flowchart illustrating a process of a refinement order of applying affine TM on a bi-prediction block, according to some embodiments of the present disclosure.

FIG. 33 is a flowchart illustrating another process of a refinement order of applying affine TM on a bi-prediction block, according to some embodiments of the present disclosure.

FIG. 34 is a flowchart of an example video decoding method, according to some embodiments of the present disclosure.

FIG. 35 is a flowchart for an example method for encoding a video bitstream, according to some embodiments of the present disclosure.

FIG. 36 is a flowchart of an example method of decoding a video bitstream, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve this goal, since 2015, the JVET has been developing technologies beyond HEVC using the joint exploration model (JEM) reference software. As coding technologies being incorporated into the JEM, the JEM achieved substantially higher coding performance than HEVC. In October 2017, a joint call for proposals (CfP) was issued by VCEG and MPEG to formally start the development of next generation video compression standard beyond HEVC. Responses to the CfP were evaluated at the JVET meeting in San Diego in April 2018, and the formal development process of the VVC standard started in April 2018.

The VVC standard has been progressing well since April 2018, and continues to include more coding technologies that provide better compression performance. VVC is based on the same hybrid video coding system that has been used in modern video compression standards such as HEVC, H.264/AVC, MPEG2, H.263, etc. In July 2020, the first version of VVC standard is finalized and is published as an international standard. Afterward, the JVET starts exploring new coding tools to further improve the coding performance of the VVC standard. In January 2021, the Enhanced Compression Model (ECM) has been proposed and used as new software base for developing tools beyond the VVC standard.

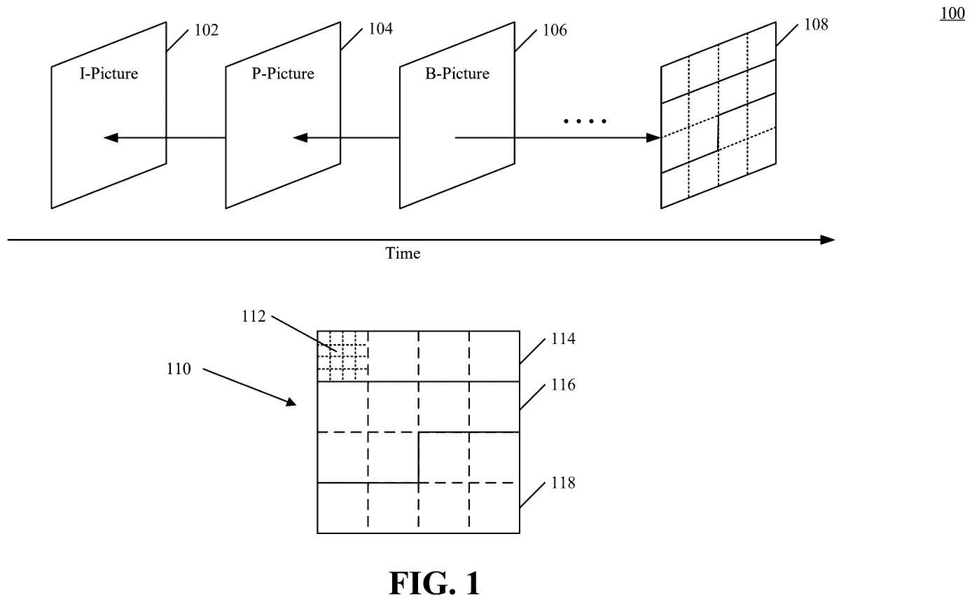

FIG. 1 illustrates structures of an exemplary video sequence, according to some embodiments of the present disclosure. Video sequence 100 can be a live video or a video having been captured and archived. Video sequence 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider. As shown in FIG. 1, video sequence 100 can include a series of pictures arranged temporally along a timeline, including pictures 102, 104, 106, and 108. Pictures 102-106 are continuous, and there are more pictures between pictures 106 and 108.

When a video is being compressed or decompressed, useful information of a picture being encoded (referred to as a “current picture”) include changes with respect to a reference picture (e.g., a picture previously encoded and reconstructed). Such changes can include position changes, luminosity changes, or color changes of the pixels. For example, position changes of a group of pixels can reflect the motion of an object represented by these pixels between two pictures (e.g., the reference picture and the current picture).

For example, as shown in FIG. 1, picture 102 is an I-picture, using itself as the reference picture. Picture 104 is a P-picture, using picture 102 as its reference picture, as indicated by the arrow. Picture 106 is a B-picture, using pictures 104 and 108 as its reference pictures, as indicated by the arrows. In some embodiments, the reference picture of a picture may be or may be not immediately preceding or following the picture. For example, the reference picture of picture 104 can be a picture preceding picture 102, i.e., a picture not immediately preceding picture 104. The above-described reference pictures of pictures 102-106 shown in FIG. 1 are merely examples, and not meant to limit the present disclosure.

Due to the computing complexity, in some embodiments, video codecs can split a picture into multiple basic segments and encode or decode the picture segment by segment. That is, video codecs do not necessarily encode or decode an entire picture at one time. Such basic segments are referred to as basic processing units (“BPUs”) in the present disclosure. For example, FIG. 1 also shows an exemplary structure 110 of a picture of video sequence 100 (e.g., any of pictures 102-108). For example, structure 110 may be used to divide picture 108. As shown in FIG. 1, picture 108 is divided into 4×4 basic processing units. In some embodiments, the basic processing units can be referred to as “coding tree units” (“CTUs”) in some video coding standards (e.g., AVS3, H.265/HEVC or H.266/VVC), or as “macroblocks” in some video coding standards (e.g., MPEG family, H.261, H.263, or H.264/AVC). In AVS3 or VVC, a coded tree unit (CTU) can be the largest block unit, and can be as large as 128×128 luma samples (plus the corresponding chroma samples depending on the chroma format).

The basic processing units in FIG. 1 are for illustrative purpose only. The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards. Operations performed to a basic processing unit can be repeatedly performed to its luma and chroma components.

During multiple stages of operations in video coding, the size of the basic processing units may still be too large for processing, and thus can be further partitioned into segments referred to as “basic processing sub-units” in the present disclosure. For example, at a mode decision stage, the encoder can split the basic processing unit into multiple basic processing sub-units and decide a prediction type for each individual basic processing sub-unit. As shown in FIG. 1, basic processing unit 112 in structure 110 is further partitioned into 4×4 basic processing sub-units. For example, a coded tree unit CTU may be further partitioned into coding units (CUs) using quad-tree, binary tree, or extended binary tree. The basic processing sub-units in FIG. 1 is for illustrative purpose only. Different basic processing units of the same picture can be partitioned into basic processing sub-units in different schemes. The basic processing sub-units can be referred to as “coding units” (“CUs”) in some video coding standards (e.g., AVS3, H.265/HEVC or H.266/VVC), or as “blocks” in some video coding standards (e.g., MPEG family, H.261, H.263, or H.264/AVC). The size of a basic processing sub-unit can be the same or smaller than the size of a basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Operations performed to a basic processing sub-unit can be repeatedly performed to its luma and chroma components. Such division can be performed to further levels depending on processing needs, and in different stages, the basic processing units can be partitioned using different schemes. At the leaf nodes of the partitioning structure, coding information such as coding mode (e.g., intra prediction mode or inter prediction mode), motion information (e.g., reference index, motion vectors (MVs), etc.) required for corresponding coding mode, and quantized residual coefficients are sent.

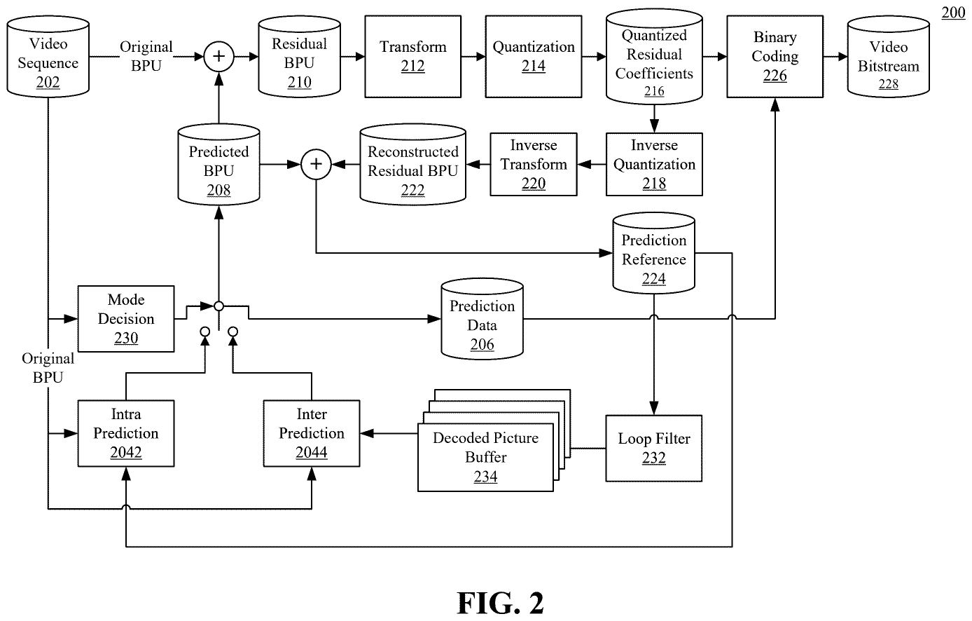

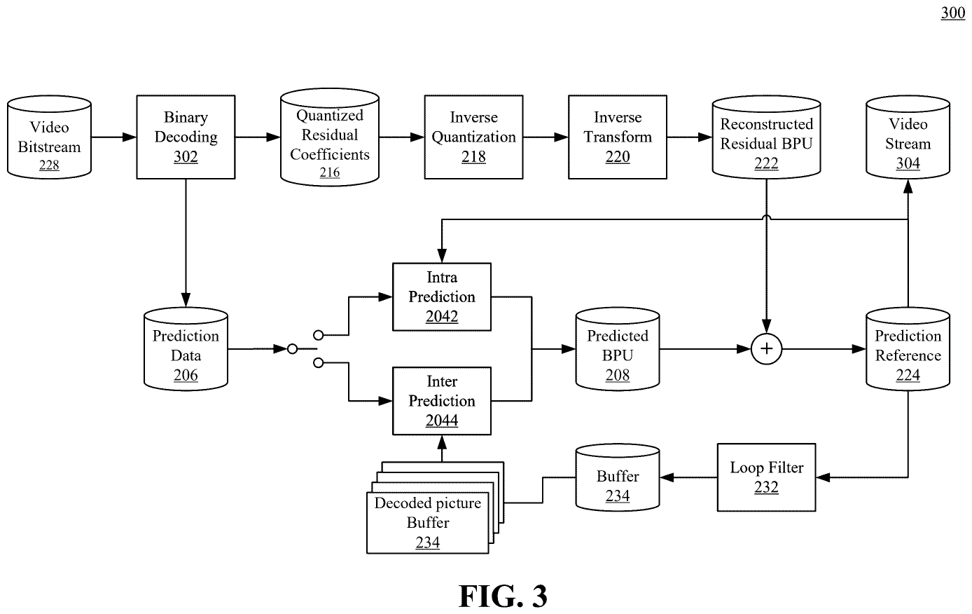

In some cases, a basic processing sub-unit can still be too large to process in some stages of operations in video coding, such as a prediction stage or a transform stage. Accordingly, the encoder can further split the basic processing sub-unit into smaller segments (e.g., referred to as “prediction blocks” or “PBs”), at the level of which a prediction operation can be performed. Similarly, the encoder can further split the basic processing sub-unit into smaller segments (e.g., referred to as “transform blocks” or “TBs”), at the level of which a transform operation can be performed. The division schemes of the same basic processing sub-unit can be different at the prediction stage and the transform stage. For example, the prediction blocks (PBs) and transform blocks (TBs) of the same CU can have different sizes and numbers. Operations in the mode decision stage, the prediction stage, the transform stage will be detailed in later paragraphs with examples provided in FIG. 2 and FIG. 3.

FIG. 2 illustrates a schematic diagram of an exemplary encoder 200 of a video coding system, (e.g., AVS3 or H.26x series), according to some embodiments of the present disclosure. The input video is processed block by block. As discussed above, in some coding standards, a coded tree unit (CTU) is the largest block unit and can be as large as 128×128 luma samples (plus the corresponding chroma samples depending on the chroma format). One CTU may be further partitioned into CUs using quad-tree, binary tree, or ternary tree. Referring to FIG. 2, encoder 200 can receive video sequence 202 generated by a video capturing device (e.g., a camera). The term “receive” used herein can refer to receiving, inputting, acquiring, retrieving, obtaining, reading, accessing, or any action in any manner for inputting data. Encoder 200 can encode video sequence 202 into video bitstream 228. Similar to video sequence 100 in FIG. 1, video sequence 202 can include a set of pictures (referred to as “original pictures”) arranged in a temporal order. Similar to structure 110 in FIG. 1, any original picture of video sequence 202 can be divided by encoder 200 into basic processing units, basic processing sub-units, or regions for processing. In some embodiments, encoder 200 can perform process at the level of basic processing units for original pictures of video sequence 202. For example, encoder 200 can perform process in FIG. 2 in an iterative manner, in which encoder 200 can encode a basic processing unit in one iteration of process. In some embodiments, encoder 200 can perform process in parallel for regions (e.g., slices 114-118 in FIG. 1) of original pictures of video sequence 202.

Components 202, 2042, 2044, 206, 208, 210, 212, 214, 216, 226, and 228 can be referred to as a “forward path.” In FIG. 2, encoder 200 can feed a basic processing unit (referred to as an “original BPU”) of an original picture of video sequence 202 to two prediction stages, intra prediction (also known as an “intra-picture prediction” or “spatial prediction”) stage 2042 and inter prediction (also known as an “inter-picture prediction,” “motion compensation,” “motion compensated prediction” or “temporal prediction”) stage 2044 to perform a prediction operation and generate corresponding prediction data 206 and predicted BPU 208. Particularly, encoder 200 can receive the original BPU and prediction reference 224, which can be generated from the reconstruction path of the previous iteration of process.

The purpose of intra prediction stage 2042 and inter prediction stage 2044 is to reduce information redundancy by extracting prediction data 206 that can be used to reconstruct the original BPU as predicted BPU 208 from prediction data 206 and prediction reference 224. In some embodiments, an intra prediction can use pixels from one or more already coded neighboring BPUs in the same picture to predict the current BPU. That is, prediction reference 224 in the intra prediction can include the neighboring BPUs, so that spatial neighboring samples can be used to predict the current block. The intra prediction can reduce the inherent spatial redundancy of the picture.

In some embodiments, an inter prediction can use regions from one or more already coded pictures (“reference pictures”) to predict the current BPU. That is, prediction reference 224 in the inter prediction can include the coded pictures. The inter prediction can reduce the inherent temporal redundancy of the pictures.

In the forward path, encoder 200 performs the prediction operation at intra prediction stage 2042 and inter prediction stage 2044. For example, at intra prediction stage 2042, encoder 200 can perform the intra prediction. For an original BPU of a picture being encoded, prediction reference 224 can include one or more neighboring BPUs that have been encoded (in the forward path) and reconstructed (in the reconstructed path) in the same picture. Encoder 200 can generate predicted BPU 208 by extrapolating the neighboring BPUs. The extrapolation technique can include, for example, a linear extrapolation or interpolation, a polynomial extrapolation or interpolation, or the like. In some embodiments, encoder 200 can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at inter prediction stage 2042, encoder 200 can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, encoder 200 can add reconstructed residual BPU 222 to predicted BPU 208 to generate a reconstructed BPU. When all reconstructed BPUs of the same picture are generated, encoder 200 can generate a reconstructed picture as a reference picture. Encoder 200 can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When encoder 200 identifies (e.g., by using a pel-recursive algorithm, a block-matching algorithm, or the like) a region similar to the original BPU in the search window, encoder 200 can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. Encoder 200 can record the direction and distance of such a motion as a “motion vector (MV).” In other words, MV is the position difference between the reference block in the reference picture and the current block in the current picture. In inter prediction, the reference block is used as the predictor for the current block, so the reference block is also called predicted block. When multiple reference pictures are used (e.g., as picture 106 in FIG. 1), encoder 200 can search for a matching region and determine its associated MV for each reference picture. In some embodiments, encoder 200 can assign weights to pixel values of the matching regions of respective matching reference pictures.

The motion estimation can be used to identify various types of motions, such as, for example, translations, rotations, zooming, or the like. For inter prediction, prediction data 206 can include, for example, reference index, locations (e.g., coordinates) of the matching region, MVs associated with the matching region, number of reference pictures, weights associated with the reference pictures, or other motion information.

For generating predicted BPU 208, encoder 200 can perform an operation of “motion compensation.” The motion compensation can be used to reconstruct predicted BPU 208 based on prediction data 206 (e.g., the MV) and prediction reference 224. For example, encoder 200 can move the matching region of the reference picture according to the MV, in which encoder 200 can predict the original BPU of the current picture. When multiple reference pictures are used (e.g., as picture 106 in FIG. 1), encoder 200 can move the matching regions of the reference pictures according to the respective MVs and average pixel values of the matching regions. In some embodiments, if encoder 200 has assigned weights to pixel values of the matching regions of respective matching reference pictures, encoder 200 can add a weighted sum of the pixel values of the moved matching regions.

In some embodiments, the inter prediction can utilize uni-prediction or bi-prediction and be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (i.e., picture 102) precedes picture 104. In uni-prediction, only one MV pointing to one reference picture is used to generate the prediction signal for the current block.

On the other hand, bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at opposite temporal directions with respect to picture 104. In bi-prediction, two MVs, each pointing to its own reference picture, are used to generate the prediction signal of the current block. After video bitstream 228 is generated, MVs and reference indices can be sent in video bitstream 228 to a decoder, to identify where the prediction signal(s) of the current block come from.

For inter-predicted CUs, motion parameters may include MVs, reference picture indices and reference picture list usage index, or other additional information needed for coding features to be used. Motion parameters can be signaled in an explicit or implicit manner. In some embodiments, under some specific inter coding modes, such as a skip mode or a direct mode, motion parameters (e.g., MV difference and reference picture index) are not coded and signaled in video bitstream 228. Instead, the motion parameters can be derived at the decoder side with the same rule as defined in encoder 200. Details of the skip mode and the direct mode will be discussed in the paragraphs below.

After intra prediction stage 2042 and inter prediction stage 2044, at mode decision stage 230, encoder 200 can select a prediction mode (e.g., one of the intra prediction or the inter prediction) for the current iteration of process. For example, encoder 200 can perform a rate-distortion optimization method, in which encoder 200 can select a prediction mode to minimize a value of a cost function depending on a bit rate of a candidate prediction mode and distortion of the reconstructed reference picture under the candidate prediction mode. Depending on the selected prediction mode, encoder 200 can generate the corresponding predicted BPU 208 (e.g., a prediction block) and prediction data 206.

In some embodiments, predicted BPU 208 can be identical to the original BPU. However, due to non-ideal prediction and reconstruction operations, predicted BPU 208 is generally slightly different from the original BPU. For recording such differences, after generating predicted BPU 208, encoder 200 can subtract it from the original BPU to generate residual BPU 210, which is also called a prediction residual.

For example, encoder 200 can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

After residual BPU 210 is generated, encoder 200 can feed residual BPU 210 to transform stage 212 and quantization stage 214 to generate quantized residual coefficients 216. To further compress residual BPU 210, at transform stage 212, encoder 200 can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, encoder 200 can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, encoder 200 and a corresponding decoder (e.g., decoder 300 in FIG. 3) can use the same transform algorithm (thus the same base patterns). Thus, encoder 200 can record only the transform coefficients, from which decoder 300 can reconstruct residual BPU 210 without receiving the base patterns from encoder 200. Compared with residual BPU 210, the transform coefficients can have fewer bits, but they can be used to reconstruct residual BPU 210 without significant quality deterioration. Thus, residual BPU 210 is further compressed.

Encoder 200 can further compress the transform coefficients at quantization stage 214. In the transform process, different base patterns can represent different variation frequencies (e.g., brightness variation frequencies). Because human eyes are generally better at recognizing low-frequency variation, encoder 200 can disregard information of high-frequency variation without causing significant quality deterioration in decoding. For example, at quantization stage 214, encoder 200 can generate quantized residual coefficients 216 by dividing each transform coefficient by an integer value (referred to as a “quantization parameter”) and rounding the quotient to its nearest integer. After such an operation, some transform coefficients of the high-frequency base patterns can be converted to zero, and the transform coefficients of the low-frequency base patterns can be converted to smaller integers. Encoder 200 can disregard the zero-value quantized residual coefficients 216, by which the transform coefficients are further compressed. The quantization process is also invertible, in which quantized residual coefficients 216 can be reconstructed to the transform coefficients in an inverse operation of the quantization (referred to as “inverse quantization”).

Because encoder 200 disregards the remainders of such divisions in the rounding operation, quantization stage 214 can be lossy. Typically, quantization stage 214 can contribute the most information loss in the encoding process. The larger the information loss is, the fewer bits the quantized residual coefficients 216 can need. For obtaining different levels of information loss, encoder 200 can use different values of the quantization parameter or any other parameter of the quantization process.

Encoder 200 can feed prediction data 206 and quantized residual coefficients 216 to binary coding stage 226 to generate video bitstream 228 to complete the forward path. At binary coding stage 226, encoder 200 can encode prediction data 206 and quantized residual coefficients 216 using a binary coding technique, such as, for example, entropy coding, variable length coding, arithmetic coding, Huffman coding, context-adaptive binary arithmetic coding (CABAC), or any other lossless or lossy compression algorithm.

For example, the encoding process of CABAC in binary coding stage 226 may include a binarization step, a context modeling step, and a binary arithmetic coding step. If the syntax element is not binary, encoder 200 first maps the syntax element to a binary sequence. Encoder 200 may select a context coding mode or a bypass coding mode for coding. In some embodiments, for context coding mode, the probability model of the bin to be encoded is selected by the “context”, which refers to the previous encoded syntax elements. Then the bin and the selected context model is passed to an arithmetic coding engine, which encodes the bin and updates the corresponding probability distribution of the context model. In some embodiments, for the bypass coding mode, without selecting the probability model by the “context,” bins are encoded with a fixed probability (e.g., a probability equal to 0.5). In some embodiments, the bypass coding mode is selected for specific bins in order to speed up the entropy coding process with negligible loss of coding efficiency.

In some embodiments, in addition to prediction data 206 and quantized residual coefficients 216, encoder 200 can encode other information at binary coding stage 226, such as, for example, the prediction mode selected at the prediction stage (e.g., intra prediction stage 2042 or inter prediction stage 2044), parameters of the prediction operation (e.g., intra prediction mode, motion information, etc.), a transform type at transform stage 212, parameters of the quantization process (e.g., quantization parameters), an encoder control parameter (e.g., a bitrate control parameter), or the like. That is, coding information can be sent to binary coding stage 226 to further reduce the bit rate before being packed into video bitstream 228. Encoder 200 can use the output data of binary coding stage 226 to generate video bitstream 228. In some embodiments, video bitstream 228 can be further packetized for network transmission.

Components 218, 220, 222, 224, 232, and 234 can be referred to as a “reconstruction path.” The reconstruction path can be used to ensure that both encoder 200 and its corresponding decoder (e.g., decoder 300 in FIG. 3) use the same reference data for prediction.

During the process, after quantization stage 214, encoder 200 can feed quantized residual coefficients 216 to inverse quantization stage 218 and inverse transform stage 220 to generate reconstructed residual BPU 222. At inverse quantization stage 218, encoder 200 can perform inverse quantization on quantized residual coefficients 216 to generate reconstructed transform coefficients. At inverse transform stage 220, encoder 200 can generate reconstructed residual BPU 222 based on the reconstructed transform coefficients. Encoder 200 can add reconstructed residual BPU 222 to predicted BPU 208 to generate prediction reference 224 to be used in prediction stages 2042, 2044 for the next iteration of process.

In the reconstruction path, if intra prediction mode has been selected in the forward path, after generating prediction reference 224 (e.g., the current BPU that has been encoded and reconstructed in the current picture), encoder 200 can directly feed prediction reference 224 to intra prediction stage 2042 for later usage (e.g., for extrapolation of a next BPU of the current picture). If the inter prediction mode has been selected in the forward path, after generating prediction reference 224 (e.g., the current picture in which all BPUs have been encoded and reconstructed), encoder 200 can feed prediction reference 224 to loop filter stage 232, at which encoder 200 can apply a loop filter to prediction reference 224 to reduce or eliminate distortion (e.g., blocking artifacts) introduced by the inter prediction. Encoder 200 can apply various loop filter techniques at loop filter stage 232, such as, for example, deblocking, sample adaptive offsets (SAO), adaptive loop filters (ALF), or the like. In SAO, a nonlinear amplitude mapping is introduced within the inter prediction loop after the deblocking filter to reconstruct the original signal amplitudes with a look-up table that is described by a few additional parameters determined by histogram analysis at the encoder side.

The loop-filtered reference picture can be stored in buffer 234 (or “decoded picture buffer”) for later use (e.g., to be used as an inter-prediction reference picture for a future picture of video sequence 202). Encoder 200 can store one or more reference pictures in buffer 234 to be used at inter prediction stage 2044. In some embodiments, encoder 200 can encode parameters of the loop filter (e.g., a loop filter strength) at binary coding stage 226, along with quantized residual coefficients 216, prediction data 206, and other information.

Encoder 200 can perform the process discussed above iteratively to encode each original BPU of the original picture (in the forward path) and generate prediction reference 224 for encoding the next original BPU of the original picture (in the reconstruction path). After encoding all original BPUs of the original picture, encoder 200 can proceed to encode the next picture in video sequence 202.

It should be noted that other variations of the encoding process can be used to encode video sequence 202. In some embodiments, stages of process can be performed by encoder 200 in different orders. In some embodiments, one or more stages of the encoding process can be combined into a single stage. In some embodiments, a single stage of the encoding process can be divided into multiple stages. For example, transform stage 212 and quantization stage 214 can be combined into a single stage. In some embodiments, the encoding process can include additional stages that are not shown in FIG. 2. In some embodiments, the encoding process can omit one or more stages in FIG. 2.

For example, in some embodiments, encoder 200 can be operated in a transform skipping mode. In the transform skipping mode, transform stage 212 is bypassed and a transform skip flag is signaled for the TB. This may improve compression for some types of video content such as computer-generated images or graphics mixed with camera-view content (e.g., scrolling text). In addition, encoder 200 can also be operated in a lossless mode. In the lossless mode, transform stage 212, quantization stage 214, and other processing that affects the decoded picture (e.g., SAO and deblocking filters) are bypassed. The residual signal from the intra prediction stage 2042 or inter prediction stage 2044 is fed into binary coding stage 226, using the same neighborhood contexts applied to the quantized transform coefficients. This allows mathematically lossless reconstruction. Therefore, both transform and transform skip residual coefficients are coded within non-overlapped CGs. That is, each CG may include one or more transform residual coefficients, or one or more transform skip residual coefficients.

FIG. 3 illustrates a block diagram of an exemplary decoder 300 of a video coding system (e.g., AVS3 or H.26x series), according to some embodiments of the present disclosure. Decoder 300 can perform a decompression process corresponding to the compression process in FIG. 2. The corresponding stages in the compression process and decompression process are labeled with the same numbers in FIG. 2 and FIG. 3.

In some embodiments, the decompression process can be similar to the reconstruction path in FIG. 2. Decoder 300 can decode video bitstream 228 into video stream 304 accordingly. Video stream 304 can be very similar to video sequence 202 in FIG. 2. However, due to the information loss in the compression and decompression process (e.g., quantization stage 214 in FIG. 2), video stream 304 may be not identical to video sequence 202. Similar to encoder 200 in FIG. 2, decoder 300 can perform the decoding process at the level of basic processing units (BPUs) for each picture encoded in video bitstream 228. For example, decoder 300 can perform the process in an iterative manner, in which decoder 300 can decode a basic processing unit in one iteration. In some embodiments, decoder 300 can perform the decoding process in parallel for regions (e.g., slices 114-118) of each picture encoded in video bitstream 228.

In FIG. 3, decoder 300 can feed a portion of video bitstream 228 associated with a basic processing unit (referred to as an “encoded BPU”) of an encoded picture to binary decoding stage 302. At binary decoding stage 302, decoder 300 can unpack and decode video bitstream into prediction data 206 and quantized residual coefficients 216. Decoder 300 can use prediction data 206 and quantized residual coefficients to reconstruct video stream 304 corresponding to video bitstream 228.

Decoder 300 can perform an inverse operation of the binary coding technique used by encoder 200 (e.g., entropy coding, variable length coding, arithmetic coding, Huffman coding, context-adaptive binary arithmetic coding, or any other lossless compression algorithm) at binary decoding stage 302. In some embodiments, in addition to prediction data 206 and quantized residual coefficients 216, decoder 300 can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, decoder 300 can depacketize video bitstream 228 before feeding it to binary decoding stage 302.

Decoder 300 can feed quantized residual coefficients 216 to inverse quantization stage 218 and inverse transform stage 220 to generate reconstructed residual BPU 222. Decoder 300 can feed prediction data 206 to intra prediction stage 2042 and inter prediction stage 2044 to generate predicted BPU 208. Particularly, for an encoded basic processing unit (referred to as a “current BPU”) of an encoded picture (referred to as a “current picture”) that is being decoded, prediction data 206 decoded from binary decoding stage 302 by decoder 300 can include various types of data, depending on what prediction mode was used to encode the current BPU by encoder 200. For example, if intra prediction was used by encoder 200 to encode the current BPU, prediction data 206 can include coding information such as a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by encoder 200 to encode the current BPU, prediction data 206 can include coding information such as a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more MVs respectively associated with the matching regions, or the like.

Accordingly, the prediction mode indicator can be used to select whether inter or intra prediction module will be invoked. Then, parameters of the corresponding prediction operation can be sent to the corresponding prediction module to generate the prediction signal(s). Particularly, based on the prediction mode indicator, decoder 300 can decide whether to perform an intra prediction at intra prediction stage 2042 or an inter prediction at inter prediction stage 2044. The details of performing such intra prediction or inter prediction are described in FIG. 2 and will not be repeated hereinafter. After performing such intra prediction or inter prediction, decoder 300 can generate predicted BPU 208.

After predicted BPU 208 is generated, decoder 300 can add reconstructed residual BPU 222 to predicted BPU 208 to generate prediction reference 224. In some embodiments, prediction reference 224 can be stored in a buffer (e.g., a decoded picture buffer in a computer memory). Decoder 300 can feed prediction reference 224 to intra prediction stage 2042 and inter prediction stage 2044 for performing a prediction operation in the next iteration.

For example, if the current BPU is decoded using the intra prediction at intra prediction stage 2042, after generating prediction reference 224 (e.g., the decoded current BPU), decoder 300 can directly feed prediction reference 224 to intra prediction stage 2042 for later usage (e.g., for extrapolation of a next BPU of the current picture). If the current BPU is decoded using the inter prediction at inter prediction stage 2044, after generating prediction reference 224 (e.g., a reference picture in which all BPUs have been decoded), decoder 300 can feed prediction reference 224 to loop filter stage 232 to reduce or eliminate distortion (e.g., blocking artifacts). In addition, prediction data 206 can further include parameters of a loop filter (e.g., a loop filter strength). Accordingly, decoder 300 can apply the loop filter to prediction reference 224, in a way as described in FIG. 2. For example, loop filters such as deblocking, SAO or ALF may be applied to form the loop-filtered reference picture, which are stored in buffer 234 (e.g., a decoded picture buffer (DPB) in a computer memory) for later use (e.g., to be used at inter prediction stage 2044 for prediction of a future encoded picture of video bitstream 228). In some embodiments, reconstructed pictures from buffer 234 can also be sent to a display, such as a TV, a PC, a smartphone, or a tablet to be viewed by the end-users.

Decoder 300 can perform the decoding process iteratively to decode each encoded BPU of the encoded picture and generate prediction reference 224 for encoding the next encoded BPU of the encoded picture. After decoding all encoded BPUs of the encoded picture, decoder 300 can output the picture to video stream 304 for display and proceed to decode the next encoded picture in video bitstream 228.

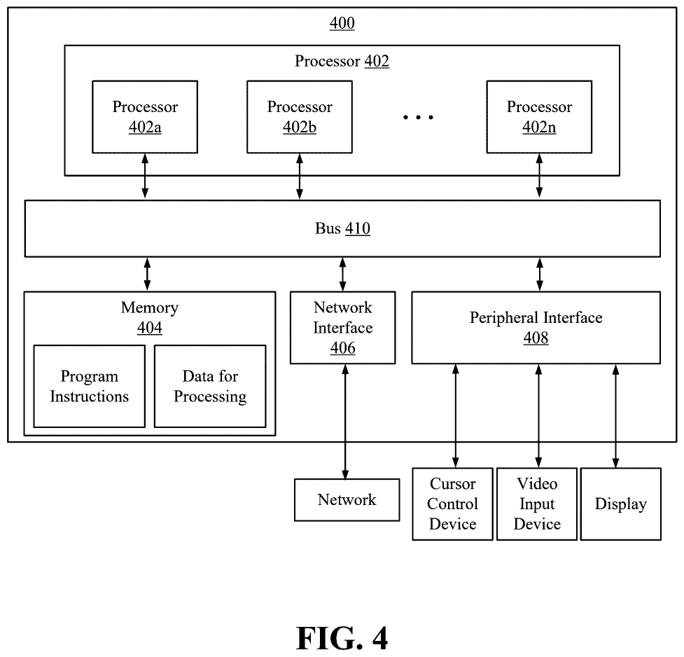

FIG. 4 is a block diagram of an exemplary apparatus 400 for encoding or decoding a video, according to some embodiments of the present disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in FIG. 2 and FIG. 3) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in the present disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, an near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process of encoder 200 or decoder 300) can be implemented as any combination of any software or hardware modules in apparatus 400. For example, some or all stages of process encoder 200 or decoder 300 can be implemented as one or more software modules of apparatus 400, such as program instructions that can be loaded into memory 404. For another example, some or all stages of process encoder 200 or decoder 300 can be implemented as one or more hardware modules of apparatus 400, such as a specialized data processing circuit (e.g., an FPGA, an ASIC, an NPU, or the like).

In the inter prediction stage 2044 in FIG. 2 and FIG. 3, reference index is used to indicate which previously coded picture the reference block is from. The motion vector (MV), the position difference between the reference block in the reference picture and the current block in the current picture, is used to indicate the position of the reference block in the reference picture. For bi-prediction (e.g., picture 106 in FIG. 1), two reference blocks, one from a reference picture in reference picture List 0 (e.g., picture 104) and the other from a reference picture in reference picture List 1 (e.g., picture 108) are used to generate the combined predicted block. Accordingly, two reference indices, (e.g., List 0 reference index and List 1 reference index), and two motion vectors (e.g., List 0 motion vector and List 1 motion vector) are required for bi-prediction. The motion vector is determined by the encoder and signaled to the decoder. In some embodiments, to save the signaling cost, a motion vector difference (MVD) is signaled in the bitstream instead. For a decoder, a motion vector predictor (MVP) can be derived based on the spatial and temporal neighboring block motion information, and the MV can be obtained by adding the MVD parsed from the bitstream to the MVP.

As discussed above, the video encoding or decoding process can be achieved using different modes. In some normal inter coding modes, encoder 200 can signal MV(s), corresponding reference picture index for each reference picture list and reference picture list usage flag, or other information explicitly per each CU. On the other hand, when a CU is coded with a skip mode or a direct mode, the motion information, including reference index and motion vector, is not signaled in video bitstream 228 to decoder 300. Instead, the motion information can be derived at decoder 300 using the same rule as encoder 200 does. The skip mode and the direct mode share the same motion information derivation rule and thus have the same motion information. A difference between these two modes is that in the skip mode, the signaling of the prediction residuals is skipped by setting residuals to be zero. In the direct mode, prediction residuals are still signaled in the bitstream.

For example, when a CU is coded with a skip mode, the CU is associated with one PU and has no significant residual coefficients, no coded MV difference or reference picture index. In the skip mode, the signaling of the residual data can be skipped by setting residuals to be zero. In the direct mode, the residual data is transmitted while the motion information and partitions are derived.

On the other hand, in inter modes, encoder 200 can choose any allowed values for motion vector and reference index as the motion vector difference and reference index are signaled to decoder 300. Compared with inter modes signaling the motion information, the bits dedicated on the motion information can thus be saved in the skip mode or the direct mode. However, encoder 200 and decoder 300 need to follow the same rule to derive the motion vector and reference index to perform inter prediction 2044. In some embodiments, the derivation of the motion information can be based on the spatial or temporal neighboring block. Accordingly, the skip mode and the direct mode are suitable for the case where the motion information of the current block is close to that of the spatial or temporal neighboring blocks of the current block.

For example, the skip mode or the direct mode may enable the motion information (e.g., reference index, MVs, etc.) to be inherited from a spatial or temporal (co-located) neighbor. A candidate list of motion candidates can be generated from these neighbors. In some embodiments, to derive the motion information used for inter prediction 2044 in skip mode or direct mode, encoder 200 may first derive the candidate list of motion candidates and select one of the motion candidates to perform inter prediction 2044. When signaling video bitstream 228, encoder 200 may signal an index of the selected candidate. At the decoder side, decoder 300 can obtain the index parsed from video bitstream 228, derive the same candidate list, and use the same motion candidate (including motion vector and reference picture index) to perform inter prediction 2044.

In some embodiments, there are different skip and direct modes, including normal skip and direct mode, ultimate motion vector expression mode, angular weighted prediction mode, enhanced temporal motion vector prediction mode and affine motion compensation skip/direct mode. The candidate list of motion candidates may include multiple candidates obtained based on different approaches. For example, for normal skip and direct model, a motion candidate list may have 12 candidates, including a temporal motion vector predictor (TMVP) candidate (i.e., a temporal candidate), one or more spatial motion vector predictor (SMVPs) candidates (i.e., spatial candidates), one or more motion vector angular predictor (MVAP) candidates (i.e., subblock based spatial candidates), and one or more history-based motion vector predictor (HMVP) candidates (i.e., history-based candidates). In some embodiments, the encoder or the decoder can first derive and add TMVP and SMVP candidates in the candidate list. After adding TMVP and SMVP candidates, the encoder or the decoder derives and add the MVAP candidates and HMVP candidates. In some embodiments, the number of MVAP candidates added in the candidate list may be varied according to the number of available direction(s) in the MVAP process. For example, the number of MVAP candidate(s) may be between 0 to a maximum number (e.g., 5). After adding MVAP candidate(s), one or more HMVP candidates can be added to the candidate list until the total number of the candidates reaches the target number and the largest number can also be signaled in the bitstream.

In some embodiments, the first candidate is the TMVP derived from the MV of collocated block in a pre-defined reference frame. The pre-defined reference frame is defined as the reference frame with reference index being 0 in the List1 for B frame or List0 for P frame. When the MV of the collocated block is unavailable, a MV predictor (MVP) derived based on the MV of spatial neighboring blocks is used as a block level TMVP.

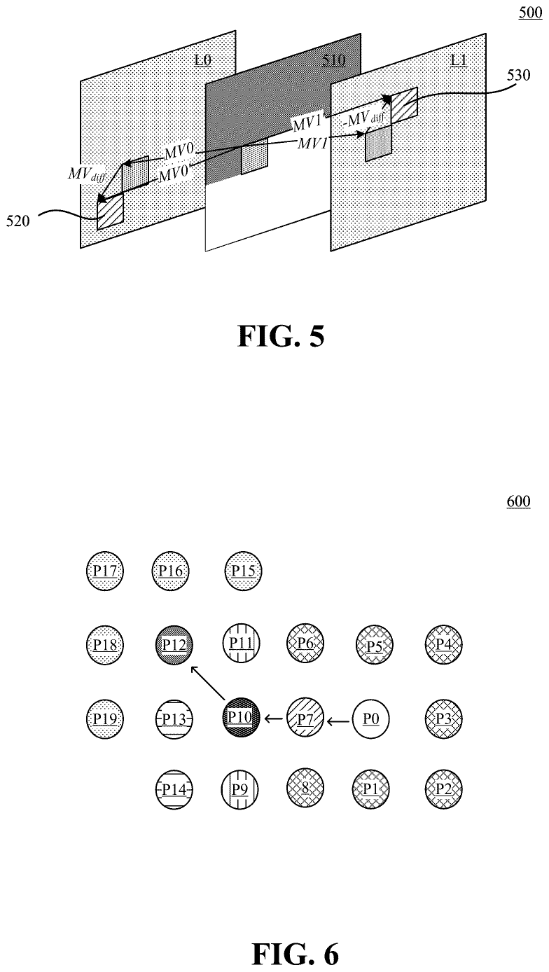

Next, decoder-side motion vector refinement (DMVR) is described. FIG. 5 illustrates an example decoding side motion vector refinement (DMVR) process 500, according to some embodiments of the present disclosure.

As illustrated in FIG. 5, in some embodiments, VVC adopts a bilateral-matching (BM) based decoder side motion vector refinement in bi-prediction operation to increase the accuracy of the MVs of the merge mode. In DMVR, for a current picture 510, a refined MV (e.g., MV₀′ and MV₁′) is searched around the initial MVs (e.g., MV₀ and MV₁) in the reference picture list L0 and reference picture list L1. The BM method calculates the distortion between the two candidate blocks in the reference picture list L0 and list L1. As illustrated in FIG. 5, the sum of absolute difference (SAD) between the blocks 520 and 530 based on each MV candidate around the initial MV is calculated. The MV candidate with the lowest SAD becomes the refined MV and used to generate the bi-predicted signal.

In VVC, the application of DMVR is restricted and is only applied for the CUs which are coded with following modes and features: (1) CU level merge mode with bi-prediction MV; (2) one reference picture is in the past and another reference picture is in the future with respect to the current picture; (3) the distances (i.e., POC difference) from two reference pictures to the current picture are same; (4) both reference pictures are short-term reference pictures; (5) CU has more than 64 luma samples; (6) both CU height and CU width are larger than or equal to 8 luma samples; (7) BCW weight index indicates equal weight; (8)WP is not enabled for the current block; (9) CIIP mode is not used for the current block.

The refined MV derived by DMVR process is used to generate the inter prediction samples and also used in temporal motion vector prediction for future pictures coding. While the original MV is used in deblocking process and also used in spatial motion vector prediction for future CU coding. The additional features of DMVR will be described in the following paragraphs.

In DMVR, the search points are surrounding the initial MV and the MV offset obey the MV difference mirroring rule. In other words, any points that are checked by DMVR, denoted by candidate MV pair (MV0, MV1) obey the following two equations:

$$MV {0}^{′} = MV 0 + MV\_offset \qquad ( 1 )$$

$$MV {1}^{′} = MV 1 - MV\_offset \qquad ( 2 )$$

where MV_offset represents the refinement offset between the initial MV and the refined MV in one of the reference pictures. The refinement search range is two integer luma samples from the initial MV. The search includes the integer sample offset search stage and fractional sample refinement stage.

25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form:

$$E ( x , y ) = {A ( x - {x}_{min} )}^{2} + {B ( y - {y}_{min} )}^{2} + C \qquad ( 3 )$$

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

$${x}_{min} = ( E ( - 1 , 0 ) - E ( 1 , 0 ) ) / ( 2 ( E ( - 1 , 0 ) + E ( 1 , 0 ) - 2 E ( 0 , 0 ) ) ) \qquad ( 4 )$$

$${y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) ) \qquad ( 5 )$$

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ, yₘᵢₙ) are added to the integer distance refinement MV to get the sub-pixel accurate refinement delta MV.

Next, bilinear-interpolation and sample padding is described. In VVC, the resolution of the MVs is 1/16 luma samples. The samples at the fractional position are interpolated using an 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DMVR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

When the width and/or height of a CU are larger than 16 luma samples, it will be further split into subblocks with width and/or height equal to 16 luma samples. The maximum unit size for DMVR searching process is limited to 16×16.

Next, multi-pass decoder-side motion vector refinement (MP-DMVR) is described. In ECM, to further improve the coding efficiency, a multi-pass decoder-side motion vector refinement is applied. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

In the first pass, a refined MV is derived by applying BM to a coding block. Similar to decoder-side motion vector refinement (DMVR), in bi-prediction operation, a refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1.

BM performs local search to derive integer sample precision intDeltaMV. The local search applies a 3×3 square search pattern to loop through the search range [−sHor, sHor] in horizontal direction and [−sVer, sVer] in vertical direction, wherein, the values of sHor and sVer are determined by the block dimension, and the maximum value of sHor and sVer is 8 or other values.

FIG. 6 illustrates an example 3×3 square search pattern 600 for the first pass in the MP-DMVR, according to some embodiments of the present disclosure. For example, as in FIG. 6, point P0 is the position to which the initial MV refers. So, the points P1-P8 surrounding the initial position are searched first and the cost of each position is calculated. If point P7 is with minimum cost, then point P7 is set as search center and points P9-P11 are searched. If cost of point P10 is smaller than the point P7, the search center goes to point P10 and points P12-P14 are searched. If point P12 has the minimum cost among points P6-14, point P12 is set as new search center. If points P10, P11, P13, and P15-P19 surrounding the point P12 are all larger than point P12, then point 12 is the best position and the search process stops.

The bilateral matching cost is calculated as: bilCost=mvDistanceCost+sadCost, wherein sadCost is the SAD between 10 predictor and 11 predictor on each search point and mvDistanceCost is based on intDeltaMV (i.e., the distance between the search point and the initial position). When the block size cbW*cbH is greater than 64, MRSAD cost function is applied to remove the DC effect of distortion between reference blocks. When the bilCost at the center point of the 3×3 search pattern has the minimum cost, the intDeltaMV local search is terminated. Otherwise, the current minimum cost search point becomes the new center point of the 3×3 search pattern and continue to search for the minimum cost, until it reaches the end of the search range.

The existing fractional sample refinement is further applied to derive the final deltaMV. The refined MVs after the first pass is then derived as:

$$MV 0 \_pass 1 = MV 0 + deltaMV$$

$$MV 1 \_pass 1 = MV 1 - deltaMV$$

In the second pass, a refined MV is derived by applying BM to a 16×16 grid subblock. For each subblock, a refined MV is searched around the two MVs (MV0_pass1 and MV1_pass1), obtained on the first pass, in the reference picture list L0 and L1. The refined MVs (MV0_pass2(sbIdx2) and MV1_pass2(sbIdx2)) are derived based on the minimum bilateral matching cost between the two reference subblocks in L0 and L1.

For each subblock, BM performs full search to derive integer sample precision intDeltaMV(sbIdx2). The full search has a search range [−sHor, sHor] in horizontal direction and [−sVer, sVer] in vertical direction, wherein, the values of sHor and sVer are determined by the block dimension, and the maximum value of sHor and sVer is 8 or other values.

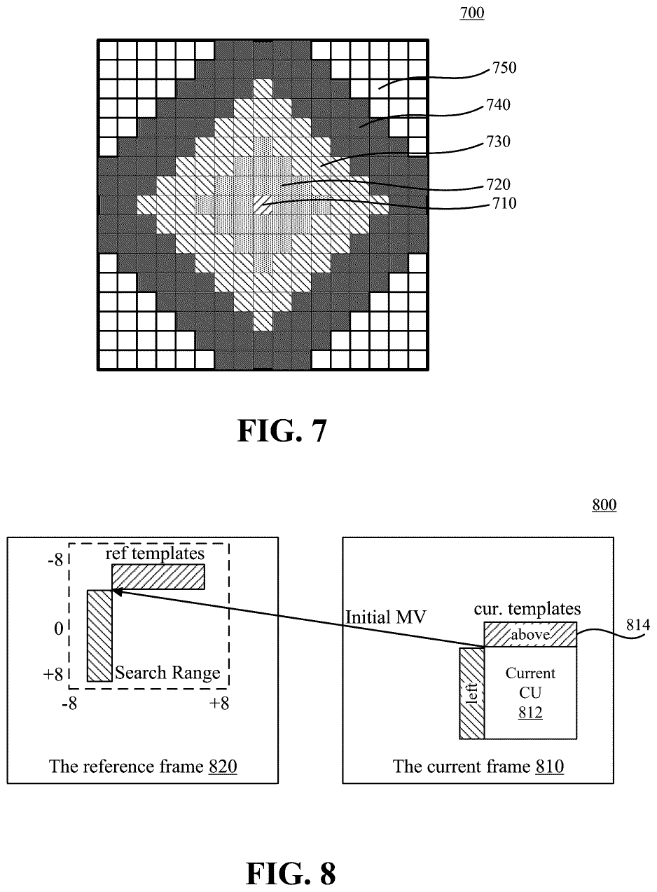

FIG. 7 illustrates an example of diamond regions 710-750 in the search area 700 for the second pass in the MP-DMVR, according to some embodiments of the present disclosure. The bilateral matching cost is calculated by applying a cost factor to the sum of absolute transformed differences (SATD) cost between two reference subblocks, as: bilCost=satdCost*costFactor. The search area (2*sHor+1)*(2*sVer+1) is divided up to 5 diamond shape search regions 710-750 shown in FIG. 7. Each search region 710-750 is assigned a costFactor, which is determined by the distance intDeltaMV(sbIdx2) between each search point and the starting MV, and each diamond region 710-750 is processed in the order starting from the center of the search area. In each region, the search points are processed in the raster scan order starting from the top left going to the bottom right corner of the region. When the minimum bilCost within the current search region is less than a threshold equal to sbW*sbH, the int-pel full search is terminated, otherwise, the int-pel full search continues to the next search region until all search points are examined. Additionally, if the difference between the previous minimum cost and the current minimum cost in the iteration is less than a threshold that is equal to the area of the block, the search process terminates.

The existing VVC DMVR fractional sample refinement can be further applied to derive the final deltaMV(sbIdx2). The refined MVs at second pass is then derived as:

$$MV 0 \_pass 2 ( sbIdx 2 ) = MV 0 \_pass 1 + deltaMV ( sbIdx 2 )$$

$$MV 1 \_pass 2 ( sbIdx 2 ) = MV 1 \_pass 1 - deltaMV ( sbIdx 2 )$$

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv(Vx, Vy) is rounded to 1/16 sample precision and clipped between −32 and 32.

The refined MVs (MV0_pass3(sbIdx3) and MV1_pass3(sbIdx3)) at third pass are derived as:

$$MV 0 \_pass 3 ( sbIdx 3 ) = MV 0 \_pass 2 ( sbIdx 2 ) + bioMv$$

$$MV 1 \_pass 3 ( sbIdx 3 ) = MV 0 \_pass 2 ( sbIdx 2 ) - bioMv$$

In ECM, adaptive decoder side motion vector refinement method is an extension of multi-pass DMVR which consists of the two new merge modes to refine MV only in one direction, either L0 or L1, of the bi prediction for the merge candidates that meet the DMVR conditions. The multi-pass DMVR process is applied for the selected merge candidate to refine the motion vectors, however either MVD0 or MVD1 is set to zero in the 1st pass (i.e., PU level) DMVR. Thus, a new merge candidate list is constructed for adaptive decoder-side motion vector refinement. And the new merge mode for the new merge candidate list is called BM merge in ECM.

The merge candidates for BM merge mode are derived from spatial neighboring coded blocks, TMVPs, non-adjacent blocks, history based motion vector predictors (HMVPs), pair-wise candidate, similar as in the regular merge mode. The difference is that only those merge candidates meeting DMVR conditions are added into the candidate list. The same merge candidate list is used by the two new merge modes. If the list of BM candidates contains the inherited BCW weights and DMVR process is unchanged except the computation of the distortion is made using MRSAD or MRSATD if the weights are non-equal and the bi-prediction is weighted with BCW weights. Merge index is coded as in regular merge mode.

FIG. 8 illustrates an example template matching process 800 performed on a search area around initial MV, according to some embodiments of the present disclosure. Template matching (TM) is a decoder-side MV derivation method to refine the motion information of the current CU 812 in the current frame 810 by finding the closest match between a template (e.g., top and/or left neighboring blocks 814 of the current CU 812) in the current frame 810 and a block (e.g., same size to the template) in a reference frame 820. As illustrated in FIG. 8, a better MV is searched around the initial motion of the current CU 812 within a [−8, +8]-pel search range. To efficiently combined with adaptive motion vector resolution (AMVR) and decoder side motion vector refinement (DMVR), the search step size of TM can be determined based on AMVR mode and TM can be cascaded with DMVR process in merge modes.

In AMVP mode, an MVP candidate is determined based on template matching error to select the one which reaches the minimum cost. The cost is calculated as the difference between the current block template and the reference block template. And then TM is performed only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 1. This search process ensures that the MVP candidate still keeps the same MV precision as indicated by the AMVR mode after TM process. In the search process, if the difference between the previous minimum cost and the current minimum cost in the iteration is less than a threshold that is equal to the area of the block, the search process terminates.

TABLE 1
Search patterns of AMVR and merge mode with AMVR

| | AMVR mode | | | | Merge mode | |
|---|---|---|---|---|---|---|
| Search | 4- | Full- | Half- | Quarter- | AltIF = | AltIF = |
| pattern | pel | pel | pel | pel | 0 | 1 |
| 4-pel | v | | | | | |
| diamond | | | | | | |
| 4-pel cross | v | | | | | |
| Full-pel | | v | v | v | v | v |
| diamond | | | | | | |
| Full-pel | | v | v | v | v | v |
| cross | | | | | | |
| Half-pel | | | v | v | v | v |
| cross | | | | | | |
| Quarter-pel | | | | v | v | |
| cross | | | | | | |
| ⅛-pel cross | | | | | v | |

In merge mode, similar search method is applied to the merge candidate indicated by the merge index. As Table 1 shows, TM may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

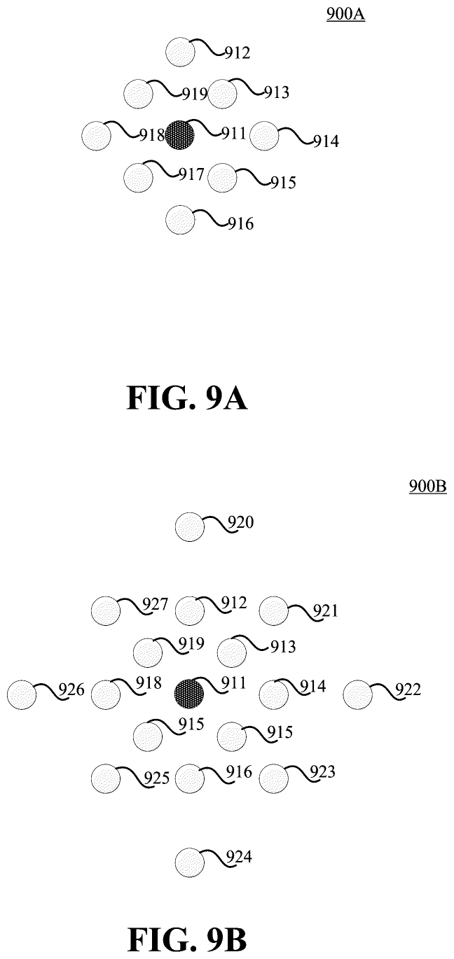

FIG. 9A and FIG. 9B illustrate example diamond search patterns 900A and 900B, according to some embodiments of the present disclosure. FIG. 9A is an 8-position diamond search pattern 900A. In each search round, the current position 911 is set as the search center and the eight neighboring positions 912-919 (the remaining positions shown in FIG. 9A around the current position 911 are checked, of which the position yields the minimum cost is selected as the next search center. FIG. 9B is 16-position diamond search pattern 900B, in which 16 neighboring positions 912-927 are checked in each search round. The search process is performed is conducted one round by round until it reaches a maximum search round number preset or the search position is over the search range. The early termination algorithm can be adopted. for example, in a search round, if the search center has the minimum cost, the search is terminated.

The sum of absolute difference (SAD) or the sum of absolute transformed difference (SATD) between templates of the current block and the reference block may be used as the template matching cost, i.e., the cost of a candidate motion vector which refers to the reference block. In some other cases, Mean removed SAD or mean removed SATD may be used as the template matching cost. The difference between template of the current block and the template of the reference block.

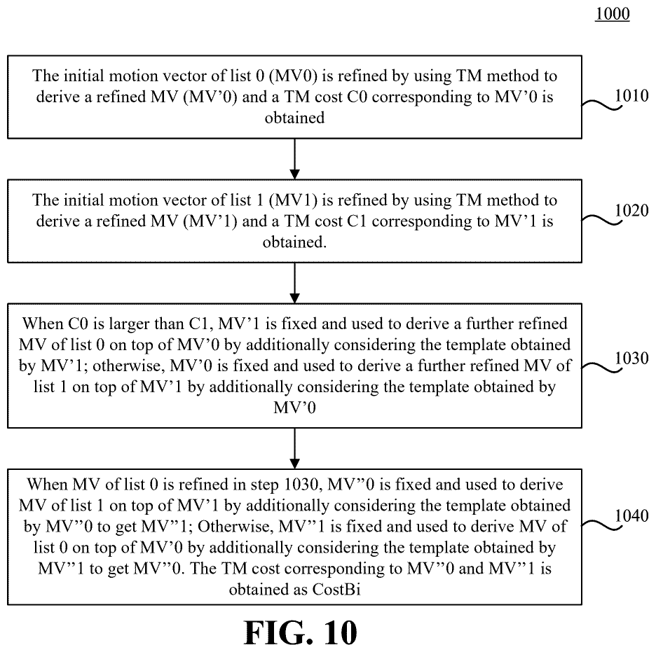

FIG. 10 is a flowchart of a template-based refinement process 1000 for bi-prediction coding blocks, according to some embodiments of the present disclosure. For bi-prediction candidate, the two MVs, one for reference picture list 0 and the other for reference picture list 1, are firstly refined independently and then an iteration process 1000 is performed to jointly refine the two MVs. The process 1000 including steps 1010-1040 is described in FIG. 10.

In step 1010, the initial motion vector of list 0 (MV0) is refined by using TM method to derive a refined MV (MV′0) and a TM cost C0 corresponding to MV′0 is obtained.

In step 1020, the initial motion vector of list 1 (MV1) is refined by using TM method to derive a refined MV (MV′1) and a TM cost C1 corresponding to MV′1 is obtained.

In step 1030, when C0 is larger than C1, MV′ is fixed and used to derive a further refined MV of list 0 on top of MV′0 by additionally considering the template obtained by MV′1. The refined MV of list 0 in this step is indicated as MV″0. Otherwise, MV′0 is fixed and used to derive a further refined MV of list 1 on top of MV′1 by additionally considering the template obtained by MV′0. The refined MV of list 1 in this step is indicated as MV″1.

In step 1040, when MV of list 0 is refined in step 1030, MV″0 is fixed and used to derive MV of list 1 on top of MV′1 by additionally considering the template obtained by MV″0 to get MV″1. Otherwise, MV″1 is fixed and used to derive MV of list 0 on top of MV′0 by additionally considering the template obtained by MV″1 to get MV″0. The TM cost corresponding to MV″0 and MV″1 is obtained as CostBi.

In the embodiments of FIG. 10, steps 1030 and 1040 may be iterated, and after refining of a bi-prediction, the cost of bi-prediction CostBi will be compared with uni prediction cost C0 or C1. If MV of list 0 is refined in the last step, CostBi is compared with C1 and if MV of list 1 is refined in the last step, CostBi is compared with C0. If CostBi is much larger than uni-prediction cost compared, the current block is converted to a uni-prediction block.

In HEVC, only translation motion model is applied for motion compensation prediction (MCP). While in the real world, there are many kinds of motion, e.g., zoom in/out, rotation, perspective motions and the other irregular motions. In VVC, a block-based affine transform motion compensation prediction is applied.

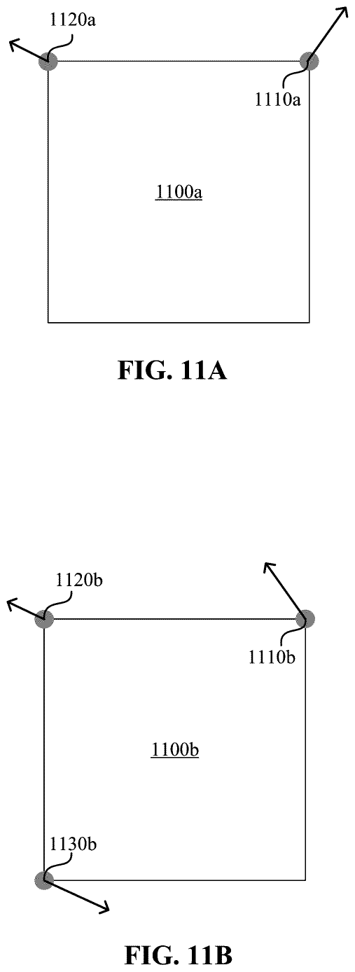

FIG. 11A and FIG. 11B are two schematic diagrams illustrating control-points-based affine model for blocks 1100a and 1100b, according to some embodiments of the present disclosure. In some embodiments, the control points 1110a and 1120a in FIG. 11A and the control points 1110b, 1120b, and 1130b in FIG. 11B are respectively set to the corners of the blocks 1100a and 1100b. As shown FIGS. 11A and 11B, the affine motion field of the block is described by motion information of two control point in 4-parameter affine motion model, or three control point motion vectors in 6-parameter affine motion model. As shown in FIG. 11A, for 4-parameter affine motion model, two control points 1110a and 1120a are needed. As shown in FIG. 11B, for 6-parameter affine motion model, three control points 1110b, 1120b, and 1130b are needed. To reduce the complexity of the model computation and the bandwidth of the motion compensation, the granularity of the affine motion compensation is on subblock level instead of sample level. In some coding standards, 4×4 or 8×8 luma subblock affine motion compensation is adopted, in which each 4×4 subblock or 8×8 subblock has a motion vector to perform motion compensation. To derive motion vector of each 8×8 or 4×4 luma subblock, the motion vector of the center position of each subblock is calculated according to two or three control points (CPs), and rounded to 1/16 fraction accuracy.

For 4-parameter affine motion model, motion vector at sample location (x, y) in a block is derived as:

$$\{ \begin{matrix}m {v}_{x} = \frac{m {v}_{1 x} - {mv}_{0 x}}{W} x + \frac{m {v}_{0 y} - m {v}_{1 y}}{W} y + m {v}_{0 x} \\ m {v}_{y} = \frac{m {v}_{1 y} - m {v}_{0 y}}{W} x + \frac{m {v}_{1 x} - m {v}_{0 x}}{W} y + m {v}_{0 y}\end{matrix} \qquad ( 6 )$$

For 6-parameter affine motion model, motion vector at sample location (x, y) in a block is derived as:

$$\{ \begin{matrix}m {v}_{x} = \frac{m {v}_{1 x} - m {v}_{0 x}}{W} x + \frac{m {v}_{2 x} - m {v}_{0 x}}{H} y + m {v}_{0 x} \\ m {v}_{y} = \frac{m {v}_{1 y} - m {v}_{0 y}}{W} x + \frac{m {v}_{2 y} - m {v}_{0 y}}{H} y + m {v}_{0 y}\end{matrix} \qquad ( 7 )$$

where (mv₀ₓ, mv_{0y}) is motion vector of the top-left corner control point, (mv₁ₓ, mv_{1y}) is motion vector of the top-right corner control point, and (mv2x, mv2y) is motion vector of the bottom-left corner control point.

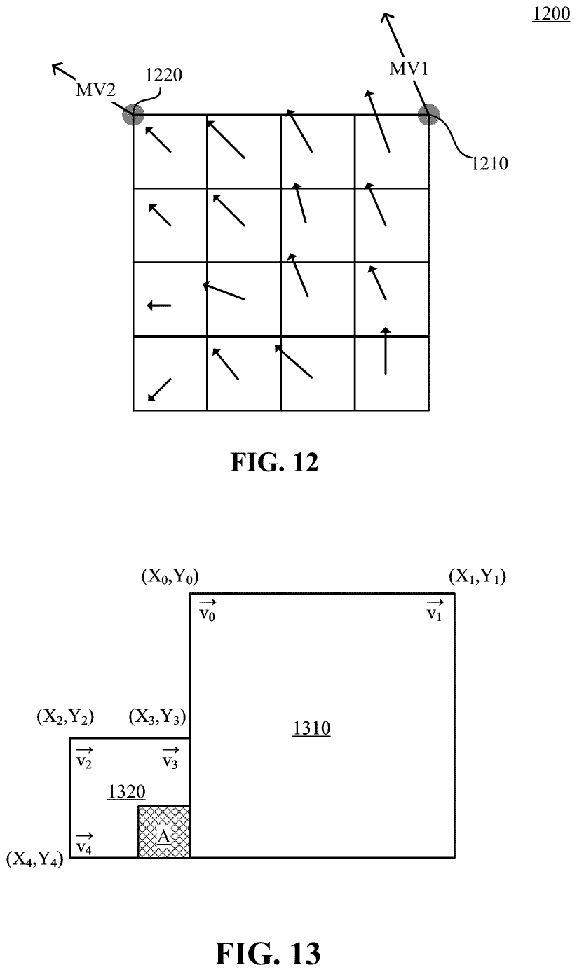

FIG. 12 is a schematic diagram illustrating motion vector of the center sample of each subblock of a block 1200, according to some embodiments of the present disclosure. Particularly, FIG. 12 gives example of four parameters affine model, in which motion vector of each subblock can be derived from the motion vectors MV1, MV2 of two control points 1210 and 1220. After derivation of subblock motion vector, the motion compensation is performed to generate the predicted block of the subblock with derived motion vector.

In order to simplify the motion compensation prediction, block based affine transform prediction can be applied. To derive motion vector of each 4×4 luma subblock, the motion vector of the center sample of each subblock, as shown in FIG. 12, is calculated according to above equations, and rounded to 1/16 fraction accuracy. In ECM, the subblock size is adaptively decided. If the motion vector difference of two neighboring luma subblock is smaller than a threshold, luma subblocks will be merged into larger subblocks. If the motion vector difference of the larger subblock is still smaller than the threshold, the larger subblock will continue to be merged until the motion vector difference of the two adjacent subblocks is larger than the threshold or until the subblock is equal to the coding unit. Then the motion compensation interpolation filters are applied to generate the prediction of each subblock with derived motion vector. The subblock size of chroma-components is dependent on the size of luma subblock. The MV of a chroma subblock is calculated as the average of the MVs of the top-left and bottom-right luma subblocks in the collocated luma region.

As done for translational motion inter prediction, there are also two affine motion inter prediction modes: affine merge mode and affine AMVP mode.

Affine merge mode (AF_MERGE) can be applied for CUs with both width and height larger than or equal to 8. In this mode the control point motion vectors (CPMVs) of the current CU is generated based on the motion information of the spatial neighboring CUs. There can be up to 15 affine candidates and an index is signaled to indicate the one to be used for the current CU.

In some embodiments, the following 8 types of candidates are used to form the affine merge candidate list: (a) inherited candidates from adjacent neighbors; (b) inherited candidates from non-adjacent neighbors; (c) constructed candidates from adjacent neighbors; (d) the second type of constructed affine candidates from non-adjacent neighbors; (e) the first type of constructed affine candidates from non-adjacent neighbors; (f) regression based affine merge candidate; (g) pairwise affine; and (h)zero MVs.

FIG. 13 illustrates control point motion vector inheritance, according to some embodiments of the present disclosure.

The inherited affine candidates are derived from affine motion model of the adjacent or non-adjacent blocks. When an adjacent or non-adjacent affine CU is identified, its control point motion vectors are used to derive the CPMVP candidate in the affine merge list of the current CU 1310. As shown in FIG. 13, if the neighboring left bottom block A is coded in affine mode, the motion vectors v₂, v₃ and v₄ of the top left corner, above right corner and left bottom corner of the CU 1320 which contains the block A are attained. When block A is coded with 4-parameter affine model, the two CPMVs of the current CU 1310 are calculated according to v₂, and v₃. In case that block A is coded with 6-parameter affine model, the three CPMVs of the current CU 1310 are calculated according to v₂, v₃ and v₄.

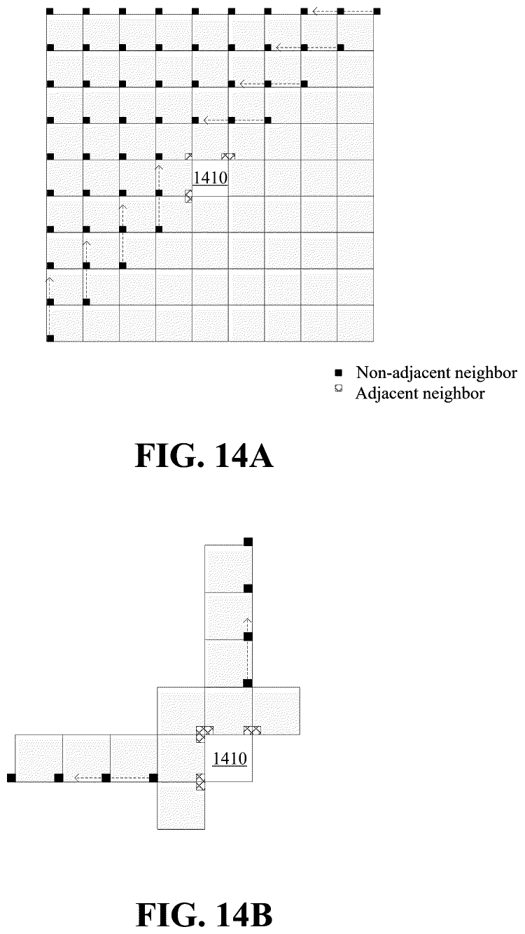

FIG. 14A and FIG. 14B illustrate spatial neighbors for deriving affine merge and affine advanced motion vector prediction (AMVP) candidates, according to some embodiments of the present disclosure. In particular, FIG. 14A illustrates spatial neighbors for deriving inherited candidates, and FIG. 14B illustrates spatial neighbors for deriving the first type of constructed candidates.

For inherited candidates from non-adjacent neighbors in FIG. 14A, the non-adjacent spatial neighbors are checked based on their distances to the current block 1410, i.e., from proximal neighbors to distal neighbors. At a specific distance, only the first available neighbor (that is coded with the affine mode) from each side (e.g., the left and above) of the current block 1410 is included for inherited candidate derivation. As indicated by the dash arrows in FIG. 14A, the checking orders of the neighbors on the left and above sides are bottom-to-up and right-to-left, respectively.

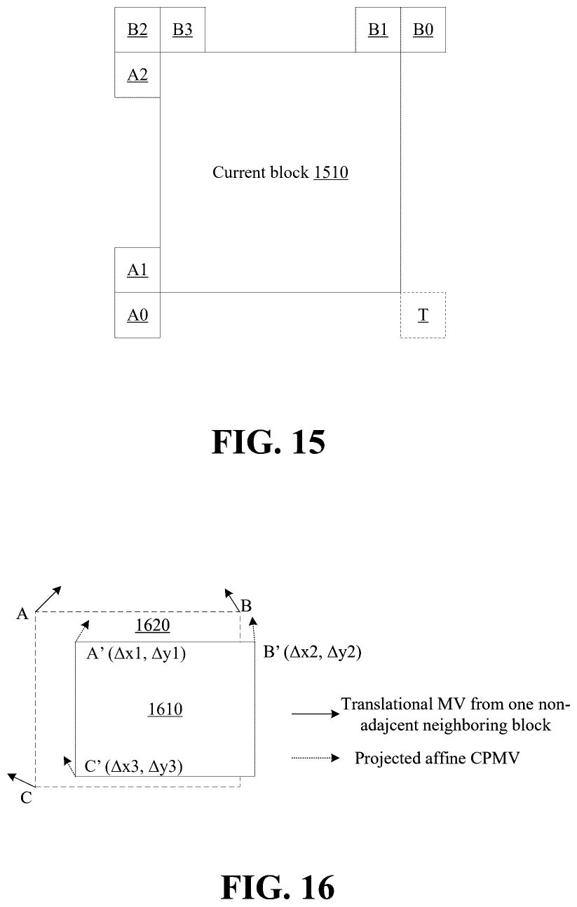

Constructed affine candidates from adjacent neighbors are the candidates constructed by combining the neighbor translational motion information of each control point. FIG. 15 illustrates locations of candidates position for constructed affine merge mode, according to some embodiments of the present disclosure.

The motion information for the control points can be derived from the specified spatial neighbors and temporal neighbor T shown in FIG. 15. CPMVₖ (k=1, 2, 3, 4) represents the k-th control point. For CPMV₁, the B2, B3, A2 blocks are checked and the MV of the first available block is used. For CPMV₂, the B1, B0 blocks are checked and for CPMV₃, the A1, A0 blocks are checked. TMVP can be used as CPMV₄ if it's available.

After MVs of four control points are attained, affine merge candidates are constructed based on those motion information. The following combinations of control point MVs are used to construct in order:{CPMV₁, CPMV₂, CPMV₃}, {CPMV₁, CPMV2, CPMV4}, {CPMV1, CPMV3, CPMV4}, {CPMV2, CPMV3, CPMV4}, {CPMV1, CPMV2}, {CPMV1, CPMV₃}.

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

For the first type of constructed candidates, as shown in FIG. 14B, the positions of one left and above non-adjacent spatial neighbors are firstly determined independently. After that, the location of the top-left neighbor can be determined accordingly which can enclose a rectangular virtual block together with the left and above non-adjacent neighbors.

FIG. 16 illustrates a first type of constructed affine merge/AMVP candidates, according to some embodiments of the present disclosure. As shown in the FIG. 16, the motion information of the three non-adjacent neighbors can be used to form the CPMVs at the top-left (A), top-right (B) and bottom-left (C) of the virtual block 1620, which is finally projected to the current CU 1610 to generate the corresponding constructed candidates.

For the second type of constructed candidates, the non-translational affine parameters are inherited from the non-adjacent spatial neighbors. Specifically, the second type of affine constructed candidates are generated from the combination of: (1) the translational affine parameters of adjacent neighboring 4×4 blocks, and (2) the non-translational affine parameters inherited from the non-adjacent spatial neighbors as defined in FIG. 14A.

For the regression based affine merge candidates, Subblock motion field from a previously coded affine CU and motion information from adjacent subblocks of a current CU are used as the input to the regression process to derive proposed affine candidates. The previously coded affine CU can be identified from scanning through non-adjacent positions and the affine HMVP table.

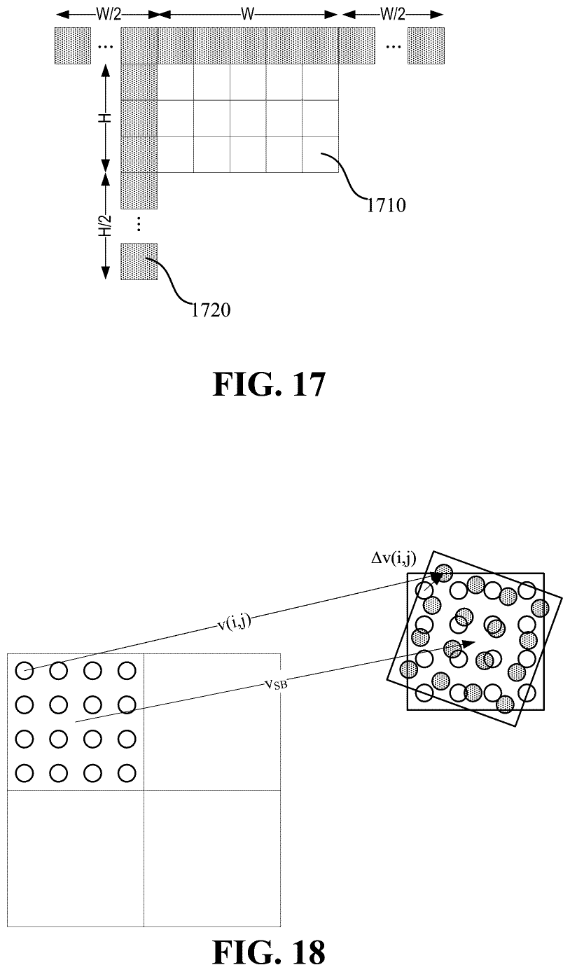

FIG. 17 illustrates neighboring 4×4 subblocks 1720 being used for regression based affine merge candidate derivation, according to some embodiments of the present disclosure. As shown in FIG. 17, 4×4 subblocks 1710 in the current CU are surrounded by neighboring 4×4 subblocks 1720, represented by the grey zone as depicted in FIG. 17. Adjacent subblock information of current CU is fetched from 4×4 subblocks 1720 represented by the grey zone as depicted in FIG. 17. For each subblock, given a reference list, the corresponding motion vector and center coordinate of the subblock may be used. For each affine CU, up to 2 regression based affine candidates can be derived, including one with adjacent subblock information and one without. All the linear-regression-generated candidates are pruned and collected into one candidate sub-group. TM cost based ARMC process is applied when ARMC is enabled. Afterwards, up to N linear-regression-generated candidates are added to the affine merge list when N affine CUs are found.

After inserting all the above candidates into the candidate list, if the list is still not full, zero MVs are inserted to the end of the list.

Next, affine advanced motion vector prediction (AMVP) mode is described. As in conventional AMVP mode, in affine AMVP mode, an AMVP candidate list is constructed with various types of candidates. One of the candidates is selected by the encoder and the index of the selected candidate to the AMVP candidate list is signaled in the bitstream. An AMVP candidate contains two CPMV predictors for a 4-parameter affine model or three CPMV predictors for a 6-parameter affine model. In AMVP mode, the CPMVs of the current coding block is not directly inherited from the AMVP candidate, but determined by the motion estimation in the encoder. And the difference between the CPMVs determined by the motion estimation and the CPMV predictors of the AMVP candidate selected are signaled in bitstream. Here, the difference signaled in the bitstream is called motion vector difference (MVD). For 6-parameter affine model which defined by the 3 CPMVs, there are 3 MVDs signaled in the bitstream and for the 4-parameter affine model which is defined by 2 CPMVs, there are MVDs signaled in the bitstream. In the decoder side, after decoding in the index of the AMVP candidate the MVDs, the AMVP candidate is determined according to index. And then, the MVDs decoded are added to the CPMV predictor of the AMVP candidate indicated by the index to get the CPMVs used in the motion compensation of the current block.

There can be up to 2 affine AMVP candidates and an index is signaled to indicate the one to be used for the current CU. Similar with affine merge mode, the following types of candidates may be also used to construct the affine AMVP candidate list: (1) inherited candidates from adjacent neighbors; (2) inherited candidates from non-adjacent neighbors; (3)constructed candidates from adjacent neighbors; (4) the second type of constructed affine candidates from non-adjacent neighbors; (5) the first type of constructed affine candidates from non-adjacent neighbors; (6) regression based affine merge candidate; (7) pairwise affine; and (8) zero MVs.

Next, Prediction refinement with optical flow for affine mode is described. Subblock based affine motion compensation can save memory access bandwidth and reduce computation complexity compared to pixel based motion compensation, at the cost of prediction accuracy penalty. To achieve a finer granularity of motion compensation, prediction refinement with optical flow (PROF) is used to refine the subblock based affine motion compensated prediction without increasing the memory access bandwidth for motion compensation. In VVC, after the subblock based affine motion compensation is performed, luma prediction sample is refined by adding a difference derived by the optical flow equation. The PROF is described as following four steps.

In step 1, the subblock-based affine motion compensation is performed to generate subblock prediction I(i,j).

In step 2, the spatial gradients gₓ(i,j) and g_{y}(i,j) of the subblock prediction are calculated at each sample location using a 3-tap filter [−1, 0, 1]. The gradient calculation can be the same as gradient calculation in BDOF and based on the following equations:

$${g}_{x} ( i , j ) = ( I ( i + 1 , j ) ≫ shift 1 ) - ( I ( i - 1 , j ) ≫ shift 1 ) \qquad ( 8 )$$

$${g}_{y} ( i , j ) = ( I ( i , j + 1 ) ≫ shift 1 ) - ( I ( i , j - 1 ) ≫ shift 1 ) \qquad ( 9 )$$

shift1 is used to control the gradient's precision. The subblock (i.e., 4×4) prediction is extended by one sample on each side for the gradient calculation. To avoid additional memory bandwidth and additional interpolation computation, those extended samples on the extended borders are copied from the nearest integer pixel position in the reference picture.

In step 3, the luma prediction refinement is calculated by the following optical flow equation:

$$Δ I ( i , j ) = {g}_{x} ( i , j ) * Δ {v}_{x} ( i , j ) + {g}_{y} ( i , j ) * Δ {v}_{y} ( i , j ) \qquad ( 10 )$$

where the Δν(i,j) is the difference between sample MV computed for sample location (i,j), denoted by ν(i, j), and the subblock MV of the subblock to which sample (i, j) belongs, as shown in FIG. 18. FIG. 18 illustrates subblock MV V_{SB} and pixel Δν(i,j), according to some embodiments of the present disclosure. The Δν(i,j) is quantized in the unit of 1/32 luma sample precision.

Since the affine model parameters and the sample location relative to the subblock center are not changed from subblock to subblock, Δν(i, j) can be calculated for the first subblock, and reused for other subblocks in the same CU. Let dx(i,j) and dy(i,j) be the horizontal and vertical offset from the sample location (i,j) to the center of the subblock (x_{SB}, y_{SB}), Δ∇(x, y) can be derived by the following equations:

$$\{ \begin{matrix}dx ( i , j ) = i - {x}_{SB} \\ dy ( i , j ) = j - {y}_{SB}\end{matrix} \qquad ( 11 )$$

$$\{ \begin{matrix}Δ {v}_{x} ( i , j ) = C * d x ( i , j ) + D * d y ( i , j ) \\ Δ {v}_{y} ( i , j ) = E * d x ( i , j ) + F * d y ( i , j )\end{matrix} \qquad ( 12 )$$

In order to keep accuracy, the center of the subblock (x_{SB}, y_{SB}) is calculated as ((WSB−1)/2, (HSB−1)/2), where WSB and HSB are the subblock width and height, respectively. For 4-parameter affine model, the coefficients C, D, E, and F are calculated based on the following equations:

$$\{ \begin{matrix}C = F = \frac{{v}_{1 x} - {v}_{0 x}}{w} \\ E = - D = \frac{{v}_{1 y} - {v}_{0 y}}{w}\end{matrix} \qquad ( 13 )$$

For 6-parameter affine model, the coefficients C, D, E, and F are calculated based on the following equations:

$$\{ \begin{matrix}C = \frac{{v}_{1 x} - {v}_{0 x}}{w} \\ D = \frac{{v}_{2 x} - {v}_{0 x}}{h} \\ E = \frac{{v}_{1 y} - {v}_{0 y}}{w} \\ F = \frac{{v}_{2 y} - {v}_{0 y}}{h}\end{matrix} \qquad ( 14 )$$

where (ν₀ₓ, ν_{0y}), (ν₁ₓ, ν_{1y}), (ν₂ₓ, ν_{2y}) are the top-left, top-right and bottom-left control point motion vectors, w and h are the width and height of the CU.

In step 4, finally, the luma prediction refinement ΔI(i, j) is added to the subblock prediction I(i, j). The final prediction I′ is generated as the following equation.

$${I}^{′} ( i , j ) = I ( i , j ) + Δ I ( i , j )$$

PROF is not applied in two cases for an affine coded CU: 1) all control point MVs are the same, which indicates the CU only has translational motion; 2) the affine motion parameters are greater than a specified limit because the subblock based affine MC is degraded to CU based MC to avoid large memory access bandwidth requirement.

The merge candidates are adaptively reordered with template matching (TM). The reordering method is applied to regular merge mode, TM merge mode, and affine merge mode (excluding the SbTMVP candidate).

An initial merge candidate list is firstly constructed according to given checking order, such as spatial, temporal motion vector predictors (TMVPs), non-adjacent, history-based motion vector predictors (HMVPs), pairwise, virtual merge candidates. Then the candidates in the initial list are divided into several subgroups. Merge candidates in each subgroup are reordered to generate a reordered merge candidate list and the reordering is according to cost values based on template matching. The index of selected merge candidate in the reordered merge candidate list is signaled to the decoder. For simplification, merge candidates in the last but not the first subgroup are not reordered. All the zero candidates from the ARMC reordering process are excluded during the construction of Merge motion vector candidates list. The subgroup size is set to 5 for regular merge mode and TM merge mode. The subgroup size is set to 3 for affine merge mode.

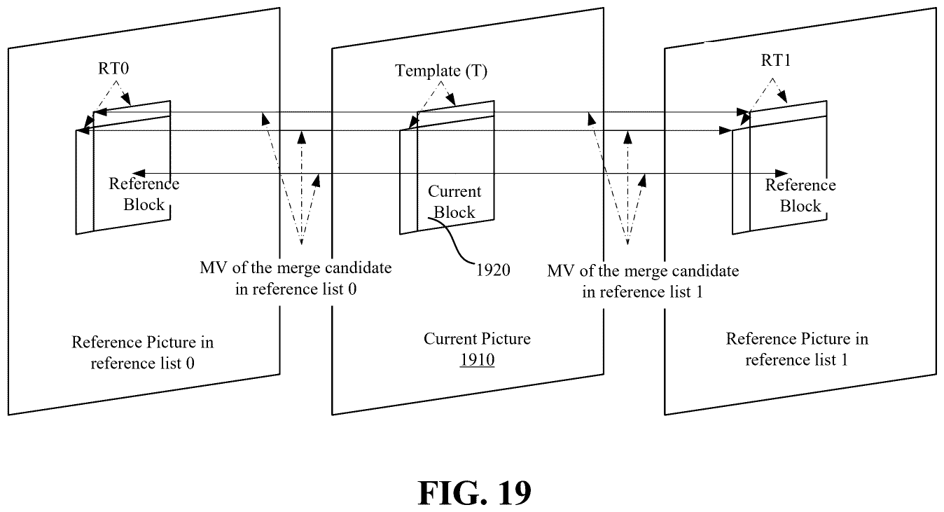

FIG. 19 illustrates a template and reference samples of the template in reference pictures, according to some embodiments of the present disclosure. As shown in FIG. 19, reference samples RT0 are the reference samples of the template T in reference list 0, and reference samples RT1 are the reference samples of the template T in reference list 1.

The template matching cost of a merge candidate during the reordering process is measured by the SAD between samples of a template of the current block and their corresponding reference samples. The template T includes a set of reconstructed samples neighboring to the current block 1920 of the current picture 1910. Reference samples RT0, RT1 of the template T are located by the motion information of the merge candidate. When a merge candidate utilizes bi-directional prediction, the reference samples RT0, RT1, of the template T of the merge candidate are also generated by bi-prediction as shown in FIG. 19.

When template matching is used to derive the refined motion, the template size is set equal to 1. Only the above or left template is used during the motion refinement of TM when the block is flat with block width greater than 2 times of height or narrow with height greater than 2 times of width. TM is extended to perform 1/16-pel MVD precision. The first four merge candidates are reordered with the refined motion in TM merge mode.

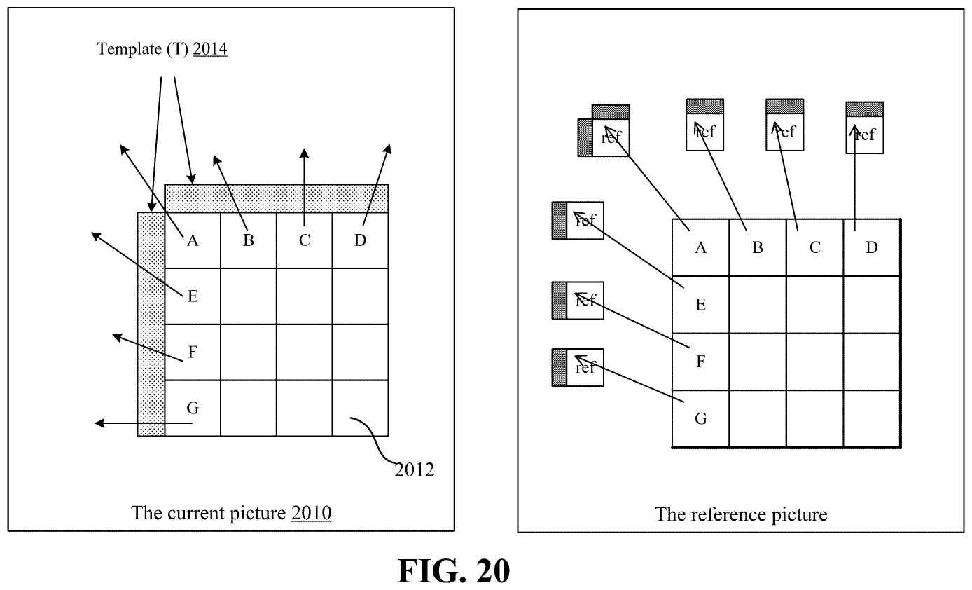

For affine merge candidates with subblock size equal to Wsub×Hsub, the above template includes several sub-templates with the size of Wsub×1, and the left template includes several sub-templates with the size of 1× Hsub. FIG. 20 illustrates a template 2014 and reference samples of the template for block with subblock motion using the motion information of the subblocks A-G of the current block 2012, according to some embodiments of the present disclosure. As shown in FIG. 20, the motion information of the subblocks A-G in the first row and the first column of current block 2012 of the current picture 2010 is used to derive the reference samples of each sub-template.

In the reordering process, a candidate is considered redundant if the cost difference between a candidate and its predecessor is inferior to a lambda value, e.g., |D1-D2|<λ, where D1 and D2 are the costs obtained during the first ARMC ordering and λ is the Lagrangian parameter used in the RD criterion at encoder side.

The proposed algorithm is defined as the following. First, the minimum cost difference between a candidate and its predecessor among all candidates in the list is determined. If the minimum cost difference is superior or equal to λ, the list is considered diverse enough and the reordering stops. If this minimum cost difference is inferior to λ, the candidate is considered redundant, and moved at a further position in the list. This further position is the first position where the candidate is diverse enough compared to its predecessor. The algorithm stops after a finite number of iterations (if the minimum cost difference is not inferior to λ).

This algorithm can be applied to the regular, TM, BM and affine merge modes. A similar algorithm can be applied to the merge MMVD and sign MVD prediction methods which also use ARMC for the reordering.

The value of λ is set equal to the k of the rate distortion criterion used to select the best merge candidate at the encoder side for low delay configuration and to the value k corresponding to a another QP for Random Access configuration. A set of λ values corresponding to each signaled QP offset is provided in the SPS or in the Slice Header for the QP offsets which are not present in the SPS.

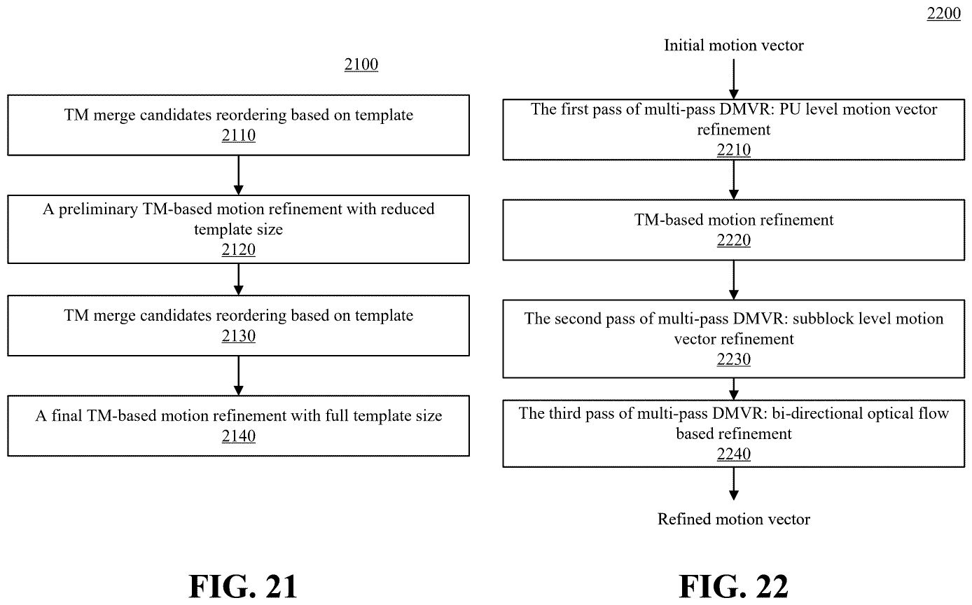

The template-based reorder is also applied on TM merge mode. FIG. 21 is a flowchart of a template-based reordering and template-based motion refinement process 2100, according to some embodiments of the present disclosure. As shown in FIG. 21, at step 2110, the TM merge candidates are reordered before the TM refinement process. At step 2120, a preliminary TM based refinement is conducted with reduced size of template. At step 2130, another TM based reordering is performed. At step 2140, the final TM based refinement is performed with full size of template. In the preliminary TM based refinement, if multi-pass DMVR is used, only the first pass (i.e., PU level) of multi-pass DMVR is applied, and in the final TM based refinement, both PU level and subblock level of multi-pass DMVR are applied.

The ARMC design is also applicable to the AMVP mode wherein the AMVP candidates are reordered according to the TM cost. For the template matching for advanced motion vector prediction (TM-AMVP) mode, an initial AMVP candidate list is constructed, followed by a refinement from TM to construct a refined AMVP candidate list. In addition, an MVP candidate with a TM cost larger than a threshold, which is equal to five times of the cost of the first MVP candidate, is skipped.

It is noted that when wrap around motion compensation is enabled, the MV candidate shall be clipped with wrap around offset taken into consideration.

Merge candidates of one single candidate type, e.g., TMVP or non-adjacent MVP (NA-MVP), are reordered based on the ARMC TM cost values. The reordered candidates are then added into the merge candidate list. The TMVP candidate type adds more TMVP candidates with more temporal positions and different inter prediction directions to perform the reordering and the selection. Moreover, NA-MVP candidate type is further extended with more spatially non-adjacent positions. The target reference picture of the TMVP candidate can be selected from any one of reference picture in the list according to scaling factor. The selected reference picture is the one whose scaling factor is the closest to 1.

In the current TM method, the TM cost is calculated based as the sample difference between current template and reference template. The difference of the initial MV and the refined MV is not considered. the initial MV in merge mode is inherited from the spatial or temporal neighboring blocks which has high correlation with the current block. Although the abundant refinement on the initial MV may be good for the template, it is not good for the current block itself. So, the MV difference between he initial MV and refined MV should be taken into consideration during the refinement.

When multi-pass DMVR and TM are both applied on the merge candidate, the first pass of multi-pass DMVR is performed firstly and followed by TM. And after TM refinement, the second pass of multi-pass DMVR is conducted, which is shown as FIG. 22. FIG. 22 is another flowchart of a template-based reordering and template-based motion refinement process 2200, according to some embodiments of the present disclosure. As shown in FIG. 22, at step 2210, the first pass of multi-pass DMVR, e.g., a PU level motion vector refinement is performed. At step 2220, the TM-based motion refinement is performed. At step 2230, the second pass of multi-pass DMVR, e.g., a subblock level motion vector refinement is performed. At step 2240, the third pass of multi-pass DMVR, e.g., a bi-directional optical flow based refinement is performed.

In some embodiments, as bilateral search scheme is used in DMVR, the MV refinement is usually less than that in TM process. So, performing multi-pass DMVR after TM process as a finer tuning could produce a better refined MV.

For bi-prediction, the TM cost of bi-prediction CostBi is compared with the TM cost of uni prediction of list 0 or list 1 (denoted as cost0_uni and cost1_uni). If cost_bi is much larger than uni-prediction cost, the bi-prediction is converted to uni-prediction. However, choosing TM cost of uni-prediction of list 0 or list 1 for comparison is dependent on which one is refined in the last step, which can not guarantee that the one selected one for comparison is a smaller one between cost0_uni and cost1_uni.

In ARMC-TM reordering process, a candidate is considered redundant if the cost difference between a candidate and its predecessor is inferior to a lambda value. And the candidate is reordered to make the difference between two consecutive candidate cost is larger than a lambda value, which is to guarantee the diversity of the candidates. However, in the current design, the diversity-based reordering is performed differently for the TM based merge list and regular merge list, which creates inconsistency.

Affine merge mode is used to capture the object with more complex motion than translation and TM is a tool to further improve the motion accuracy which is inherited from the previously coded blocks without MV offset signaling. In the current design, TM is only applied in regular merge mode, but not applied in affine merge mode. however, the affine motion inherited from the previously coded blocks may not perfectly match with the current block. So, template matching based refinement is helpful.

The present disclosure provides solutions to one or more of the above-described problems. In some embodiments, the TM cost is extended by taking MV offset into consideration to give a penalty of a search position far away from the initial position. The MV offset here refers to the difference between the refined MV and the initial MV. Thus, a large MV refinement itself gives a big cost, which prevents the refined MV goes too far away from the initial MV which is derived from the neighboring blocks.

Assuming MV0=(mv0ₓ, mv0_{y}) denotes the initial MV before TM refinement and the MV=(mvₓ, mv_{y}) denotes the MV of each search point. Then the MV cost, denoted as cost(MV) can be derived as shown in the following equation:

$$cost ( MV ) = ( \vert mv {0}_{x} - m {v}_{x} \vert + \vert mv {0}_{y} - m {v}_{y} \vert )$$

and TM cost which denoted as cost(TM) can be a weighted sum of MV cost and sample cost, as shown in the following equation:

$$cost ( TM ) = cost ( sample ) + w \times Cost ( MV ) .$$

The sample cost is derived according to the sample difference between the template of the current block and the template of the reference cost. It can be SAD or SATD of the two templates.

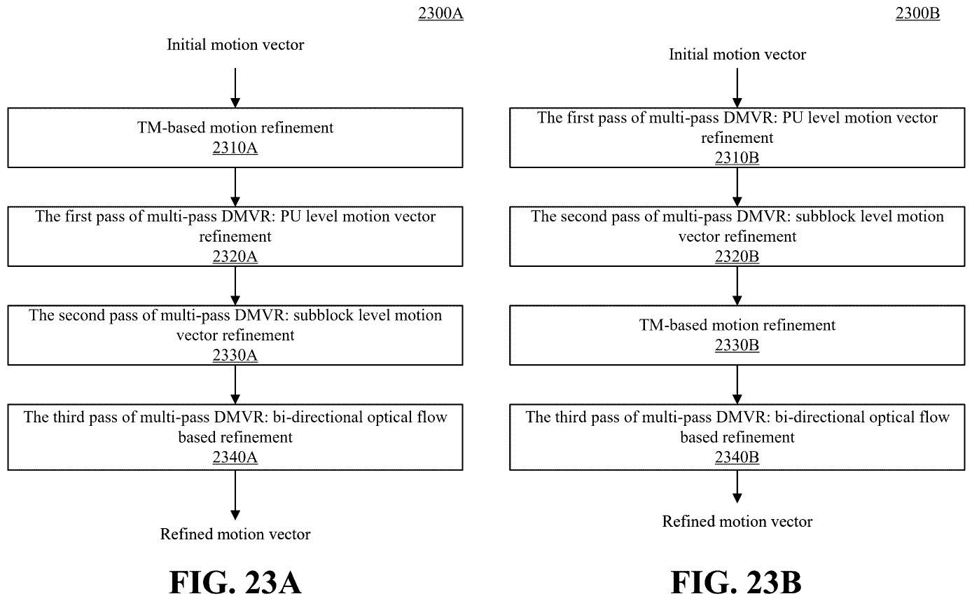

FIG. 23A and FIG. 23B are flowcharts of template-based reordering and template-based motion refinement processes 2300A and 2300B, according to some embodiments of the present disclosure. In the embodiments of FIG. 23A, the template matching based refinement and bilateral matching based refinement can be both applied on a coding block. In some embodiments, when TM and multi-pass DMVR are both applied on a coding block, the TM is performed first as MV offsets derived by TM is usually larger than that derived by DMVR. Conducting TM before DMVR could make it easy to reach an optimal MV value. So, for each merge candidate, the TM refinement is performed based on the initial MV and a TM refined MV is output. Then based on TM refined MV, if the coding block satisfies the DMVR condition, the DMVR is performed based in the TM refined MV and a DMVR refined MV is output and used as the final MV for motion compensation. The process 2300A is shown as FIG. 23A. As shown in FIG. 23A, at step 2310A, the TM-based motion refinement is performed. Then, at step 2320A, the first pass of multi-pass DMVR, e.g., a PU level motion vector refinement is performed. Then, at step 2330A, the second pass of multi-pass DMVR, e.g., a subblock level motion vector refinement is performed. At step 2340A, the third pass of multi-pass DMVR, e.g., a bi-directional optical flow based refinement is performed, to obtain the refined motion vector.

As TM refinement will check uni-prediction TM cost and bi-prediction TM cost, it will also convert a bi-prediction block into uni-prediction. And DMVR can only be applied on bi-prediction block. So, performing TM before DMVR will make some coding blocks loss the chance being refined by DMVR if these coding blocks are converted into uni-prediction. Thus, in some other embodiments, the TM is performed after DMVR or after the second pass of multi-pass DMVR, which is shown as the process 2300B in FIG. 23B. As shown in FIG. 23B, at step 2310B, the first pass of multi-pass DMVR, e.g., a PU level motion vector refinement is performed. Then, at step 2320B, the second pass of multi-pass DMVR, e.g., a subblock level motion vector refinement is performed. Then, at step 2330B, the TM-based motion refinement is performed. Then, at step 2340B, the third pass of multi-pass DMVR, e.g., a bi-directional optical flow based refinement is performed, to obtain the refined motion vector.

When TM is applied on a bi-prediction coding block, each of the two MVs will be refined separately as uni-prediction. The two MVs refined as uni-prediction are denoted as MV0_uni and MV1_uni, the corresponding TM cost are denoted as cost0_uni and cost1_uni. After refinement of each MV, the two MVs are further refined jointly as bi-prediction. To reduce the complexity of joint refinement of two MVs, the refinement is implemented with an iteration process. That is, fixing one MV and refining another MV and then fixing the refined MV and refining the fixed MV. The refinement process is described in FIG. 10. During the refinement, the two templates of the two reference blocks, one from reference picture list 0 and the other from reference picture 1, are combined to get template of the predicted block and the TM cost of the bi-prediction, denoted as cost_bi, is calculated based on the difference between the template of the current block and the template of the predicted block. Finally, the TM cost of bi-prediction will be compared with TM cost of uni-prediction, cost0_uni or cost1_uni. If uni-prediction has a less TM cost, the current coding block is converted to a uni-prediction block. In the current design, if MV of list 0 is refined at last, cost_bi is compared with cost1_uni and if MV of list 1 is refined at last, cost_bi is compared with cost0_uni.

In some embodiments, it is proposed to compare TM cost of bi-prediction with the smaller one of TM costs of uni-prediction, which is not related with which MV being refined at last. The process can be described in pseudo code as follows.

```
if(cost0_uni < cost1_uni)
{
  cost_uni = cost0_uni
  MV_uni=MV0_uni
}
else
{
  cost_uni=cost1_uni
  MV_uni=MV1_uni
}
if(cost_bi > K × cost_uni)
{
  set the current coding block as uni-prediction
  set the motion vector of the coding block as MV_uni
}
```

where K is a factor larger than 1.

The merge candidates are adaptively reordered with template matching (TM). For regular merge candidate, the diversity of the candidates is considered in the reordering. A candidate is considered redundant if the cost difference between a candidate and its predecessor is inferior to a lambda value. A redundant candidate is moved at a further position in the list. This further position is the first position where the candidate is diverse enough compared to its predecessor. So, the cost difference between two consecutive candidates are compared with the lambda value and the candidate is moved to a further position in the list if the difference of the candidate cost and its predecessor is less than the lambda value. However, for TM merge candidate, the smaller one between the cost of the first candidate cost and cost difference of two consecutive candidates are compared with the lambda value. Even if the cost difference of any consecutive candidates is larger than the lambda value, the first candidate will be moved to a further position if the cost of the first candidate itself is less than the lambda.

In some embodiments, in order to make consistency design between regular merge candidate reordering and TM candidate reordering, the first candidate cost is not considered in the TM candidate reordering. That is, the diversity based reordering method is the same for regular merge candidate and TM merge candidate. Only the cost difference of two consecutive candidates are compared with the lambda value and if the cost difference is less than the lambda value, the later one of the two consecutive candidate is move to a further position that has a cost sufficiently different from its new predecessor.

In some embodiments, the diversity-based reordering is not applied for TM merge candidates. After constructing the TM merge candidates list, the candidates are reordered based on the template cost, and then each candidate is refined by template matching based refinement. There is no diversity-based reordering is conducted.

In some embodiments, the ARMC is extended to the affine AMVP mode. That is, after the AMVP candidate list is constructed, the candidates are reordered according to the TM cost. The template used here is the same with that used the affine merge candidate reordering. For example, the template of the reference block can be shown as FIG. 20. Assume subblock size of the affine block is equal to Wsub×Hsub, the above template includes several sub-templates with the size of Wsub×1, and the left template includes several sub-templates with the size of 1×Hsub. The motion information of the subblocks in the first row and the first column of current block is used to derive the reference samples of each sub-template.

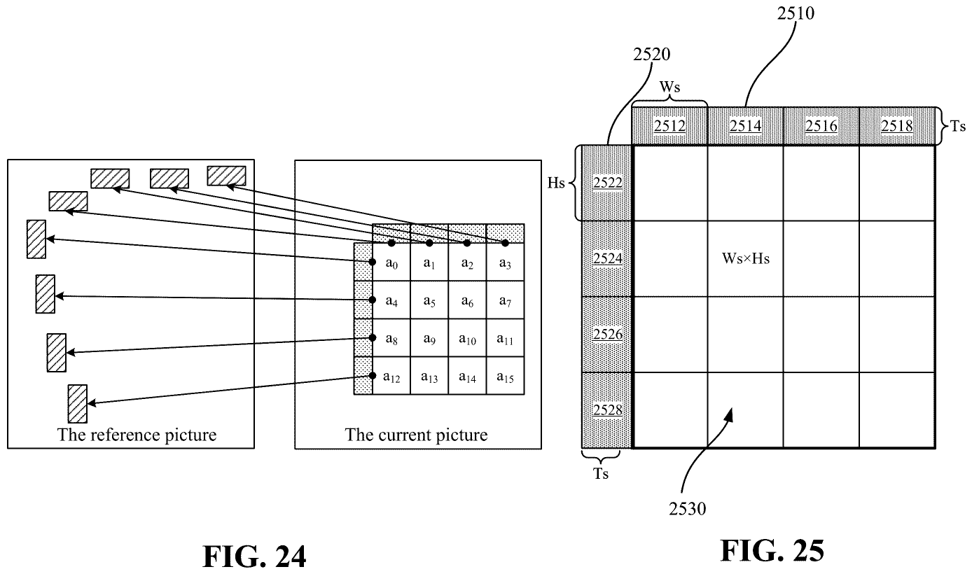

FIG. 24 illustrates templates of a reference block used in the AMVP candidate reordering and TM based refinement, according to some embodiments of the present disclosure.

For example, as shown FIG. 24, first, the MVs at the center of top boundary of subblock a0, a1, a2 and a3, and the MVs at the center of left boundary of subblock a0, a4, a8 and a12 are derived with the affine model equation. Then, these derived boundary MVs are used to get the sub-templates from the reference picture which are shown as the dashed area. These sub-templates make up the template of the reference block. The template of the current coding block is shown as dotted area in FIG. 24. The TM cost used in the reordering is calculated as the SAD between the template of the reference block and the template of the current coding block, and only one top neighboring row and one left neighboring column are used as the template to control the complexity.

In the current design of AMVP candidate list construction, only the first two available candidates are kept in the list. Thus, it is also proposed to the extend the candidate number during the AMVP candidate list construction. For example, when the AMVP candidate list is being constructed, the different types of candidates are checked one by one, the maximum number is to set to N. When the candidate number reaches N, the check process terminates; if the number of candidates is less than N even after all the candidate are checked, zero candidates which contains zero CPMVs are inserted to the candidate list until the number of candidates in the candidate list equal to 5. After it, ARMC is performed with ascending order of TM cost. After reordering, in order not to increase the candidate index signaling cost, only the first K (K<N) candidates are kept. Then the encoder only needs to select the best candidate from these K candidates and indicate it in the bitstream. The decoder determines the candidate used from these K candidates according the candidate index signaled in the bitstream. In another example, K can be 1. That is, after reordering, only the first candidate is kept. In that case, the encoder directly uses the first candidate as the CPMV predictor and there is no need to signal the candidate index. In the decoder side, after AMVP candidate list constructed, ARMC is performed and then the first candidate is used as the CPMV predictor without decoding the candidate index from the bitstream. The CPMV differences are decoded from the bitstream and added to the CPMV predictors to get CPMVs for the following decoding process. By doing this, the signaling overhead is reduced and the coding efficiency increases.

In some embodiments, the template matching based refinement is applied to affine merge mode to improve the accuracy of the affine motion which is inherited from the previously coded blocks.

To apply the template matching based refinement, the TM affine merge list is derived first. In one example, the TM affine merge list is the same as the regular affine merge list. That is, the same candidates are used for regular affine merge mode and TM affine merge mode. For regular affine merge mode, one of the candidates is selected and indicated in the bitstream. The motion of the selected candidate is used for motion compensation. for TM affine merge mode, the motion of the candidates are refined by TM and the refined motion of the selected candidate is used for motion compensation.

As TM merge mode, the motion will be refined by TM. So, in another example, a different affine merge candidate list is constructed by considering TM influence. In the TM merge candidate list, the similarity of the candidates is checked. If a candidate to be inserted into the list is similar with the existing candidates in the list, the candidate will not be inserted as the similar candidate may produce the same motion after TM refinement. To check the similarity of the two affine merge candidates, the difference of CPMVs of the affine candidates are calculated and compared with the threshold. Suppose a first affine merge candidate has three CPMVs as CPMV0=(mv0_x, mv0_y), CPMV1=(mv1_x, mv1_y), CPMV2=(mv2_x, mv2_y), and a second merge candidate has three CPMVs as CPMV0′=(mv0_x′, mv0_y′), CPMV1′=(mv1_x′, mv1_y′), CPMV2′=(mv2_x′, mv2_y′). The first affine candidate and the second affine candidate is similar with each other if the following condition is satisfied:

$$\{ \begin{matrix}\vert mv0\_x - {mv0\_x}^{′} \vert < TH0\_x \\ \vert mv0\_y - {mv0\_y}^{′} \vert < TH0\_y \\ \vert mv1\_x - {mv1\_x}^{′} \vert < TH1\_x \\ \vert mv1\_y - {mv1\_y}^{′} \vert < TH1\_y \\ \vert mv2\_x - {mv2\_x}^{′} \vert < TH2\_x \\ \vert mv2\_y - {mv2\_y}^{′} \vert < TH2\_y\end{matrix} \qquad ( 15 )$$

where TH0_x, TH0_y, TH1_x, TH1_y, TH2_x, TH2_y are thresholds which may be dependent on the coding block size. All the types of affine candidate, including inherited candidate from adjacent neighbors and non-adjacent neighbors, constructed candidates from adjacent neighbors, the first type of constructed candidates from non-adjacent neighbors, the second type of constructed candidates from non-adjacent neighbors, regression-based candidates, pairwise affine candidate.

FIG. 25 illustrates an above template 2510 and a left template 2520 for affine motion compensation, according to some embodiments of the present disclosure. As affine motion compensation is performed in subblock level, template of affine merge candidate also includes several sub-templates. As shown in FIG. 25, if the template size used in TM is equal to Ts and the affine merge candidates with subblock size equal to Ws×Hs, the above template 2510 includes several sub-templates 5212-2518 with the size of Ws×Ts, and the left template 2520 includes several sub-templates 5222-2528 with the size of Ts×Hs. In FIG. 25, the white region is a current affine motion coded coding block 2530 including 16 subblocks, and the shaded area is a template including 4 above sub-templates 5212-2518 with size of Ws×Ts and 4 left sub-templates 5222-2528 with size of Ts×Hs. Ts is the size of the template. For example, it can be 1, 2, 3 or 4.

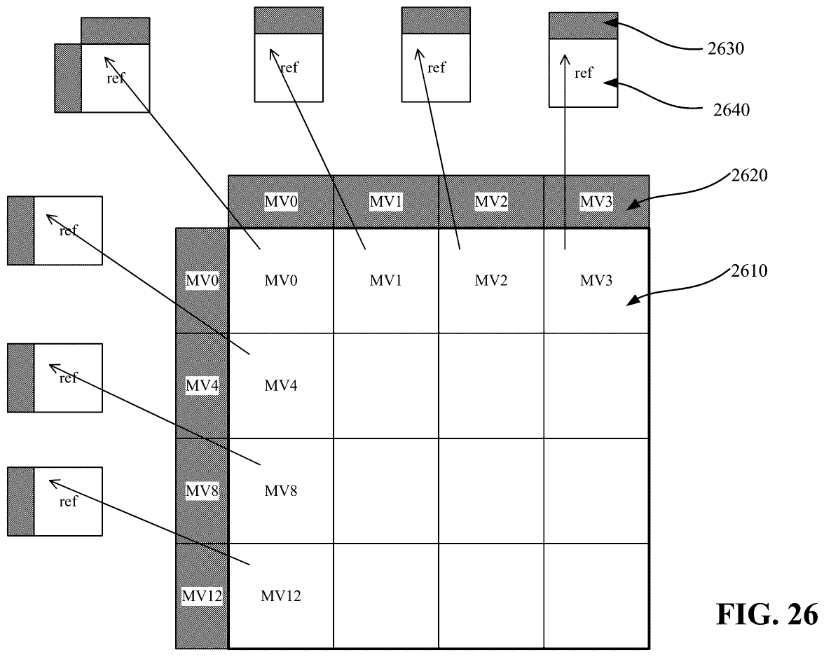

To get the template of the reference block, the MV of each subblock template need to be derived. In one example, the MV of each sub-template is borrowed from the boundary subblock. That is, the MV of a sub-template is the same as the MV of the adjacent subblock within the current coding block. FIG. 26 illustrates MVs of sub-templates of an affine motion codec block, according to some embodiments of the present disclosure. As shown in FIG. 26, the white subblocks are the subblocks 2610 of the current coding block and the shaded subblocks are the sub-templates 2620. The MV value (i.e., MV0, MV1, MV2, MV3, MV4, MV8 and MV12) of the boundary subblock 2610 is the same as MV of the sub-templates 2620. Thus, the sub-templates 2630 of reference blocks are adjacent to the reference subblocks 2640 which are marked as “ref.”

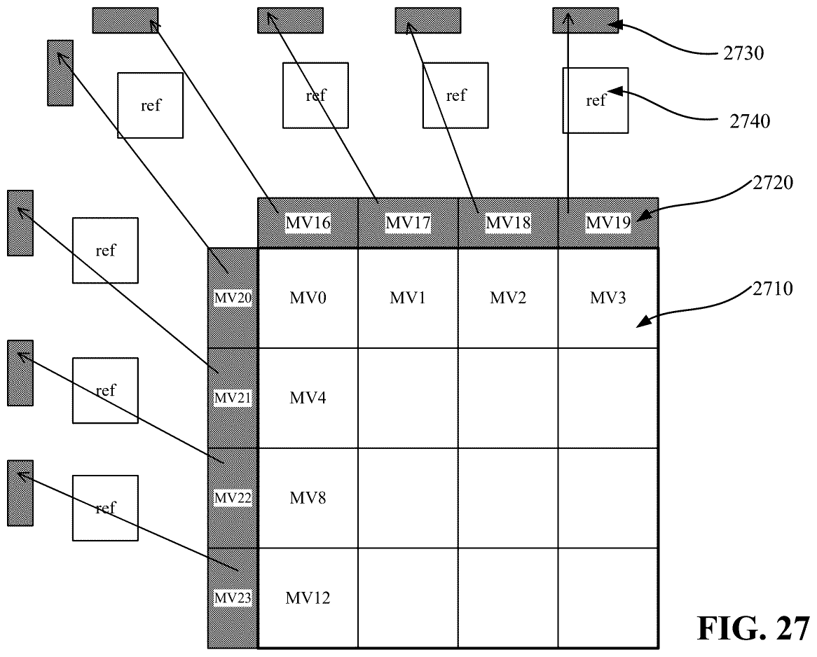

In some other examples, the MV of sub-template can be derived according to the affine model based on the coordinate of each sub-template. Thus, each sub-template has its own MV which may be different from that of boundary subblock. FIG. 27 illustrates MVs of sub-templates of an affine motion codec block, according to some embodiments of the present disclosure. As shown in FIG. 27, the boundary subblocks 2710 have MV values marked as MV0, MV1, MV2, MV3, MV4, MV8 and MV12, and the sub-templates 2720 have MV values marked as M16 to MV23. As the sub-template MVs may be different from the boundary subblock MVs, the sub-templates 2730 of the reference block may be separated from reference subblocks 2740.

For an affine model, motion vector at sample location (x, y) can be formulated as

$$\{ \begin{matrix}{mv}_{x} = ax + by + {mv}_{0 x} \\ {mv}_{y} = cx + dy + {mv}_{0 y}\end{matrix} \qquad ( 16 )$$

wherein (mνₓ, mν_{y}) is the derived motion vector at sample location (x, y), (mν₀ₓ, mν_{0y}) is called based MV in the model which is the motion vector at sample location (0, 0), and a, b, c, d are the parameters of the affine model which can be derived based on the motion vectors at other two sample locations in the plane. Generally, base MV in the model can be the motion vector at any sample location, not necessarily at location (0, 0). If we choose motion vector at sample location (w, h) as the base MV (denoted as (mν_{wx}, mν_{hy}), then motion vector at sample location (x, y) can be formulated as

$$\{ \begin{matrix}{mv}_{x} = a ( x - w ) + b ( y - h ) + {mv}_{w x} \\ {mv}_{y} = c ( x - w ) + d ( y - h ) + {mv}_{h y}\end{matrix} \qquad ( 17 )$$

For 4-parameters affine model, b is equal to −c and d is equal to a. Thus, 4-parameter affine model can be formulated as

$$\{ \begin{matrix}{mv}_{x} = a ( x - w ) - c ( y - h ) + {mv}_{w x} \\ {mv}_{y} = c ( x - w ) + a ( y - h ) + {mv}_{h y}\end{matrix} \qquad ( 18 )$$

Theoretically, all the parameters of affine model, including a, b, c, d and mν_{wx}, mν_{yy} can be refined in DMVR. However, to restrict the complexity, in some embodiments of this disclosure, it is proposed to fix the affine parameter a, b, c and d, and only refine base MV (mν_{wx}, mν_{hy}). That is, the template only has translation motion in the searching process. In each search position, all the sub-templates have the same MV offset compared with the initial MV. Thus, the three CPMVs and the subblock MVs also have a same MV offset after refinement. If CPMV0, CPMV1 and CPMV2 are the three initial CPMVs and sbMV is a subblock MV before refinement, then after refinement, the refined CPMVs, denoted as CPMV0′, CPMV1′ and CPMV2′ and the refined subblock MV sbMV′ obey the following equations.

$${CPMV}^{′} = CPMV 0 + MV\_offset \qquad ( 19 )$$

$$CPMV {1}^{′} = CPMV 1 + MV\_offset \qquad ( 20 )$$

$$CPMV {2}^{′} = CPMV 2 + MV\_offset \qquad ( 21 )$$

$${sbMV}^{′} = sbMV + MV\_offset \qquad ( 22 )$$

where MV_offset is the MV refinement in the TM refinement process (i.e., a MV offset producing the best TM cost).

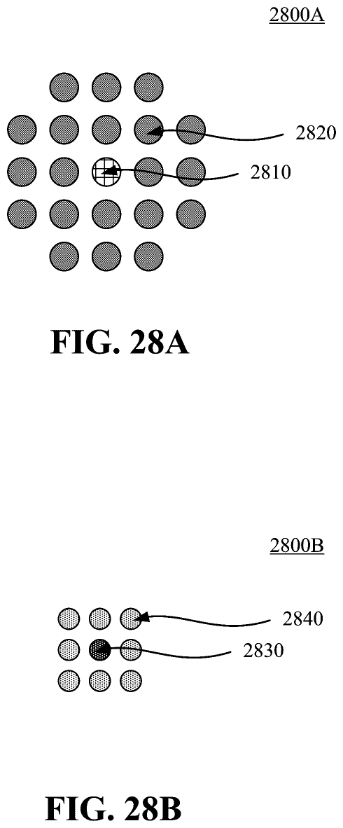

FIG. 28A illustrates an integer template matching (TM) search process 2800A, according to some embodiments of the present disclosure. FIG. 28B illustrates a half-pixel TM search process 2800B, according to some embodiments of the present disclosure. In some embodiments, all the search patterns, including cross search, 8-position diamond search, 16-position diamond search pattern can be used. For example, as shown FIG. 28A, to reduce the search complexity, in the integer TM search process 2800A, the circle 2810 is the initial position and only the 20 positions around the initial position (i.e., the remaining circles 2820 in FIG. 28A) are searched. The position with the minimum TM cost is obtained as the best position in the integer search and it is set as the initial position in the following fractional search process. As shown in FIG. 28B, to reduce the complexity, the circle 2830 is the best integer position obtained in the integer search process, and the 8 half-pixel positions around the best integer position (i.e., the remaining circles 2840 in FIG. 28B) are searched in the fractional search process 2800B. The position with the minimum TM cost is obtained as the best position in the fractional search and output as the optimal position and the corresponding MV is referred as the refined MV.

The affine TM refinement can also be applied together with affine DMVR on an affine coded block. In that case, TM refinement process can be before DMVR, or can be after base MV refinement of affine DMVR but before affine model parameter refinement of affine DMVR, or after affine DMVR.

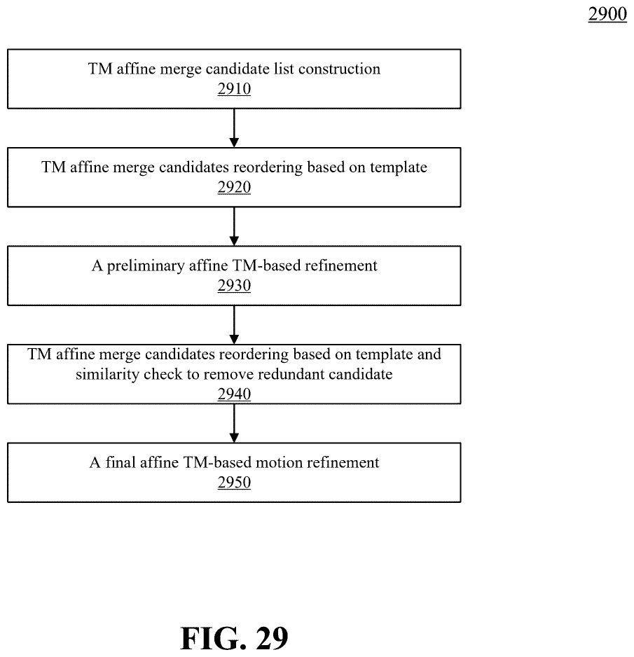

Template-based reordering of merge candidate can also be performed to TM merge candidate. For example, after TM affine merge candidate list construction, the candidates are reordered based on the template. And then the TM refinement is applied on the candidates in the lists, and after TM refinement, another template-based reordering and candidate similarity check can be performed to remove the redundant candidate. A second TM refinement can be applied after then. FIG. 29 is a flowchart of a process 2900 of an affine merge mode, according to some embodiments of the present disclosure. FIG. 29 gives a processing order example for affine merge mode. As shown in FIG. 29, process 2900 includes steps 2910-2950. In step 2910, a TM affine merge candidate list is constructed. In step 2920, the TM affine merge candidates are reordered based on the template. In step 2930, a preliminary affine TM-based refinement is performed. In step 2940, TM affine merge candidates are reordered based on the template and similarity check to remove redundant candidate. In step 2950, a final affine TM-based motion refinement is performed.

In some embodiments, to further improve the affine model accuracy, the non-translation parameters are also refined in TM refinement. one way to refine the non-translation parameters is to add offsets to the initial parameters to get refined parameters, and then derive CPMVs, subblock MVs or sub-template MVs from the refined non-translation parameters. The template matching cost is obtained by calculating the difference of the template of the current block and the template of the reference block which are fetched according to sub-template MVs.

In some embodiments, affine non-translation parameter search is performed. For affine model

$$\{ \begin{matrix}m {v}_{x} = a ( x - w ) + b ( y - h ) + m {v}_{w x} \\ {mv}_{y} = c ( x - w ) + d ( y - h ) + m {v}_{h y}\end{matrix} \qquad ( 23 )$$

the non-translation parameter a, b, c and d are searched in the parameter space. For a search position with parameter values equal to a′, b′, c′ and d′, it can be expressed as

$$\{ \begin{matrix}{a}^{′} = a + offset\_a \\ {b}^{′} = b + offset\_b \\ {c}^{′} = c + offset\_c \\ {d}^{′} = c + offset\_d\end{matrix} \qquad ( 24 )$$

where offset_a, offset_b, offset_c and offset_d are the parameter offsets searched in the TM refinement process. After getting values of a′, b′, c′, d′, the subblock MVs and sub-template MVs can be derived according to the affine model with a′, b′, c′, d′. And the TM cost can be calculated as the difference between the template of reference block and the template of the current block. By comparing the TM costs corresponding to different values of offset_a, offset_b, offset_c and offset_d, the best non-translation parameter a′, b′, c′, d′ can be obtained as the refined non-translation parameters and the corresponding CPMVs can be calculated as the refined CPMVs.

To reduce the search complexity, the 2-parameter search can be applied. That is, offset_b is constrained to be equal to −offset_c and offset d is constrained to be equal to offset_a. So, the encoder and the decoder only need to search for offset_a and offset_b, and derive offset_b and offse_d according to offset_a and offset_b. It is called 2 parameter refinement in this disclosure.

The MV search method can be applied in parameter search. For example, for 2 parameter refinement, as shown above in FIG. 6, the 3×3 square search scheme or 3×3 cross search scheme may be applied to get the best parameter offset. For 4 parameter refinement, the search is conducted in 4-dimension space. The 3×3×3×3 square search or 3×3×3×3 cross search scheme may be applied to get the best parameter offset. For 3×3×3×3 square search scheme, for each central position, there are 80 neighboring positions to be searched, and for 3×3×3×3 cross search, for each central position, there are 8 neighboring positions to be searched, which is much less than 3×3×3×3 square search. Suppose the parameter offset of the current central position is (offset_a, offset_b, offset_c, offset_d), the eight neighboring positions to be searched in 3×3×3×3 cross search scheme is (offset_a+step_a, offset_b, offset_c, offset_d), (offset_a−step_a, offset_b, offset_c, offset_d), (offset_a, offset_b+step_b, offset_c, offset_d), (offset_a, offset_b, −step_b offset_c, offset_d), (offset_a, offset_b, offset_c+step_c, offset_d), (offset_a, offset_b, offset_c−step_c, offset_d), (offset_a, offset_b, offset_c, offset_d+step_d), (offset_a, offset_b, offset_c, offset_d−step_d), where step_a, step_b, step_c and step_d are search step for parameter a, b, c, and d, respectively. After getting the best parameter offset, error surface based offsets estimation could also be applied to further refine the parameter with higher precision. The search step could be step as a fixed value. For example, as the MV precision is 1/16 in ECM and the basic subblock for affine motion compensation is 4×4, the search step can be 1/64 such that the MV difference of two adjacent subblocks is 1/64*4= 1/16, which is the minimum difference for a MV. The search step could be larger than 1/64. A larger search step reduces the search round to save the search time but loss the refinement precision. In another example, the search step is dependent on the CU size. Assume the width of CU is w and the height of CU is h, the search step for a and c is denoted as step_ac and the search step for d and b is denoted as step_db. The search step may satisfy the following condition:

$$\{ \begin{matrix}w \times step\_ac = T 1 \\ h \times step\_bd = T 2\end{matrix} \qquad ( 25 )$$

wherein T1 and T2 are two thresholds, which can be 1/16, ⅛, ¼ or other values. This threshold defines the MV difference for the sample in the current coding that is farthest away from the sample with the base MV can be generated during each step of search. It is noted that, in this example, different parameters have different search steps.

For the cost of each search point, the difference of the parameter offsets could also be considered. That is, the cost could be a weighted sum of the SAD or SATD between the template of the reference block and the template of the current block as TMCost=w*ParameterOffsetCost+sadCost, wherein w is a weight, sadCost is the SAD/SATD or mean removed SAD/SATD cost of the templates and ParameterOffsetCost is a cost dependent on the parameter offset of the refined parameters. When w is equal to 0, only sadCost is considered.

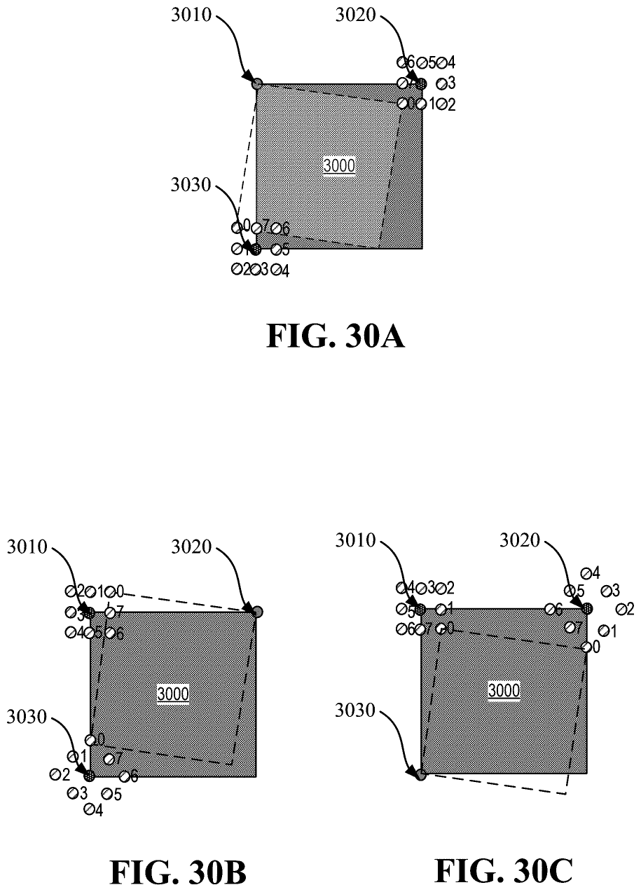

When search for the affine parameters, the base MV could be fixed. Theoretically, MV at any point in the plane can be fixed as base MV. In some embodiments, the CPMV is fixed as base MV. FIG. 30A illustrates refining affine parameters by fixing a top-left control point motion vector (CPMV) as a base MV, according to some embodiments of the present disclosure. FIG. 30B illustrates refining affine parameters by fixing a top-right CPMV as a base MV, according to some embodiments of the present disclosure. FIG. 30C illustrates refining affine parameters by fixing a bottom-left CPMV as a base MV, according to some embodiments of the present disclosure. For example, the top-left CPMV 3010 is fixed, and the affine parameters are refined shown as FIG. 30A. With the change of the parameters, the coding block 3000 rotates and zoom in/out, so the top-right CPMV 3020 and the right-bottom CPMV 3030 are also changed. And then the subblock MV is derived with the refined parameters and the new CPMV, and the motion compensation is performed. FIG. 30B and FIG. 30C provide the example of fixing top-right CPMV 3020 and the bottom-left CPMV 3030 as base MV, respectively, and refining 4 affine parameters. Similar to the embodiments shown in FIG. 30A, with the refinement of affine parameters, the coding block 3000 rotates and zoom in/out, so the non-fixed CPMVs are changed. In some embodiments, different CPMVs are fixed as the base MV in turn. That is, the search processing is divided into several steps. In the first step, the top-left CPMV 3010 is fixed as the base MV and the parameters are searched as shown in FIG. 30A. With the best parameters obtained, the top-right CPMV 3020 can be calculated. Then in the second step, as shown in FIG. 30B, the refined top-right CPMV 3020 is fixed and the parameters are refined again. With the best parameters obtained in the second step, the left-bottom CPMV 3030 can be calculated. And then in the third step, the refined left-bottom CPMV 3030 is fixed and the parameters are refined again as shown in FIG. 30C. The steps can be repeated several times. That is, the third step can be followed by the first step with new top-left CPMV 3010 fixed as base MV. And the process can continue until some conditions are satisfied. For example, the conditions could be but not limited to: (1) a pre-set iteration number; (2) the SAD or SATD between reference template and the current template less than a threshold; (3) the current fixed CPMV is the same or similar as that in last iteration; or (4) the offset of the parameters in this round of search is less than a threshold.

As described above, the affine parameter refinement process is similar with the base MV refinement process. The search process is conducted one round by one round. For each round, if the template matching cost of the central position is less than all the neighboring position, the current central position is found as the best position and the search process terminates; otherwise, the neighboring position with the least template matching cost is set as a new center position and the search goes to the next round. To control the search complexity, a maximum number of search round is set at both encoder and decoder side. Thus, the search process terminates either the central position is with the least cost or the search round number achieves the pre-set maximum number. A larger maximum search round number can give more coding performance gain but takes longer encoding and decoding time. Accordingly, to make a good trade-off between complexity and performance, the maximum search round may be dependent on fixed base MV, QP, temporal layer, CU size, etc. For example, as the search process as shown in FIGS. 30A-30C, in the first step, the top-left CPMV is fixed as the base MV, the maximum search round number is set to a large value as it is the first time parameters are refined the larger search round can exploit coding performance. Then in the second step, the top-right CPMV is fixed as base MV, the maximum search round number is set to a small value as the parameters are already refined in the first step and a small search round number can save coding time. Then in the third step, the bottom-left CPMV is fixed as base MV, the maximum search round number is set to a smaller value to further save coding time. Thus, in the disclosed embodiments, the maximum search round number is set to a larger value in the beginning and changed to a smaller value in the later steps.

In some embodiments, the maximum search round number of the later steps is dependent on the actual search round number of previous steps. For example, in the first step when the top-left CPMV is set as base MV, the maximum search round number is set to N. However, during the first step search, the search process terminates in the k-th (k<N) search round as the central position has the minimum template matching cost. Then in the second step, the maximum search round number is set to k/2 (or other values dependent on k and less than P). If in the first step search round, the search process achieves the maximum search round number, then in the second step, the maximum search round number is set to P, which is a value less than N. The similar method can be applied in the third step. If the actual search round number of the second step achieves the maximum number, the maximum search round number of the third step is set to is L where L is less than P; if the actual search round number is t that doesn't achieve the maximum number, the maximum search round number of the third step is set to t/2. Thus, the maximum search round number is adaptively determined by the previous search process.

In some embodiments, to reduce the complexity, the search neighboring positions of a search round is reduced adaptively according to the previous search round. For example, in the 3×3×3×3 cross search scheme, there are eight neighboring positions to be searched in each search round. Suppose the current center is (a, b, c, d) and the eight neighboring positions to be checked are pa0=(a+s, b, c, d), pa1=(a−s, b, c, d), pb0=(a, b+s, c, d), pb1=(a, b−s, c, d), pc0=(a, b, c+s, d), pc1=(a, b, c−s, d), pd0=(a, b, c, d+s) and pd1=(a, b, c, d−s), respectively. The template matching cost of eight neighboring positions are denoted as cost_pa0, cost_pa1, cost_pb0, cost_pb1, cost_pc0, cost_pc1, cost_pd0, and cost_pd1. Compare cost_pa0 and cost_pa1, if cost_pa0 is less than cost_pa1, then only positive offset is considered for parameter a in the next round, if cost_pa0 is greater than cost_pa1, then only minus offset is considered for parameter a in the next round. Compare cost_pb0 and cost_pb1, if cost_pb0 is less than cost_pb1, then only positive offset is considered for parameter b in the next round, if cost_pb0 is greater than cost_pb1, then only minus offset is considered for parameter b in the next round. Compare cost_pc0 and cost_pc1, if cost_pc0 is less than cost_pc1, then only positive offset is considered for parameter c in the next round, if cost_pc0 is greater than cost_pc1, then only minus offset is considered for parameter c in the next round. Compare cost_pd0 and cost_pd1, if cost_pd0 is less than cost_pd1, then only positive offset is considered for parameter d in the next round, if cost_pd0 is greater than cost_pd1, then only minus offset is considered for parameter d in the next round. Suppose for the current search round, cost_pa0 is less than cost_pa1, cost_pb0 is greater than cost_pb1, cost_pc0 is less than cost_pc1 and cost_pd0 is greater than cost_pd1, then in the next round the four neighboring positions to be checked are (a′+s, b′, c′, d′), (a′, b′−s, c′, d′), (a′, b′, c′+s, d′) and (a′, b′, c′, d′−s) where (a′, b′, c′, d′) is the center position of the next round search.

In some embodiments, the minimum template matching cost of the current search round is compared with that of last search round. If the minimum cost reduction is a small amount, the search process terminates. For example, if the cost of last search round is A, which means the cost of the current search center is A, the minimum cost of the neighboring positions is B at position posb, where B<A. According to search rule, the search goes to the next round with search center posb. However, in some embodiments, if A−B<K or B>A×f, the search process terminates and the posb is selected as the best position is this search step. K and f are pre-set thresholds. For example, f is a factor less than 1, like 0.95, 0.9 or 0.8.

Quantization Parameter (QP) controls the quantization in video coding. With a higher QP, a bigger quantization step is used, and thus more distortion is introduced. So, for higher QP, more search rounds are needed in the refinement and it increases more encoding time. To reduce the total coding time, in some embodiments, it is proposed to have a smaller maximum search round number in higher QP than in lower QP. Other methods for reducing complexity may also be used in high QP. for example, reducing the neighboring positions to be searched, adaptively reducing the search round or early terminating the search process dependent on the previous search process may be used. Thus, in the disclosed embodiments, different search strategies may be adopted in different QPs. In some embodiments, as a high QP introduces more distortion which requires more refinement, a smaller maximum search round number is set for low QP and a greater maximum search round number is set for high QP to keep the coding efficiency and reduce the complexity at the same time. Other methods for reducing complexity may also be used in low QP, as low QP case may not need to much refinement.

The search rounds may also be dependent on the sequence resolution. For example, for video sequences with large resolution, the maximum search round number or the neighboring positions to be searched in each round is set to a big value and for the video sequences with small resolution, the maximum search round number or the neighboring positions to be searched in each round is set to a small value.

Inter-coded frame, like B frame and P frame, has one or more reference frames. The time distance between the current frame and reference frame impacts the accuracy of the inter prediction. The time distance between two frames in video coding is usually represented by picture order count (POC) distance. Usually, with a longer POC distance, the inter prediction accuracy is lower and the motion information accuracy is also lower, and thus it needs more refinement. Thus, in the disclosed embodiments, the search process depends on the POC distance between the current frame and the reference frame. For hierarchical B frame, the frame with a higher temporal layer has short POC distance to the reference frame and the frame with a lower temporal layer has longer POC distance to the reference frame. So, the search process can also depend on the temporal layer of the current frame. For example, disable the affine parameter refinement for the high temporal layer as high temporal layer has short POC distance to the reference frame and may not need refinement. In another example, set a small search round or reduce neighboring search positions for high temporal layer frame. Also, other methods to reduce the complexity of parameter refinement could be used for the high temporal layer frame. So, in the disclosed embodiments, the parameter refinement process depends on the temporal or the POC distance between the current frame and the reference frame.

In some embodiments, affine model search can be used. In the above embodiments, the affine parameters are directly refined. However, affine motion including translation, rotation and zooming. The translation is represented by the base MV, and rotation and zooming are represented by the affine parameters. So, in some embodiments, the motion of rotation and zoom is refined. That is, based on the original affine model, an additional rotation and scaling is added. If the original affine model is described as the following equations:

$$\{ \begin{matrix}{mv}_{x} = ax + by + {mv}_{0 x} \\ {mv}_{y} = cx + dy + {mv}_{0 y}\end{matrix} \qquad ( 26 )$$

wherein (mνₓ, mν_{y}) is the derived motion vector at sample location (x, y). then a rotation with angle t and scaling with factor k is applied as the following equation:

$$\vert \begin{matrix}{mv}_{x} \\ {mv}_{y}\end{matrix} \vert = k \vert \begin{matrix}cos t & - sin t \\ sin t & cos t\end{matrix} \vert \vert \begin{matrix}ax + by + {mv}_{0 x} \\ cx + dy + {mv}_{0 y}\end{matrix} \vert \qquad ( 27 )$$

t and k are two parameters to be searched during the DMVR process. The current search methods can be applied to get the best value of t and k. Then the subblock MV is derived with equation 43 and subblock level motion compensation is performed to get the predictor of the current affine-coded block.

All the existing early termination method in the MV refinement method can also be applied in the parameter refinement process. For example, during the refinement process, if the SAD/SATD between two predictors are less than a threshold, the search process is terminated.

In some embodiments, CPMV search can be performed. The TM search is not conducted directly on on-translation parameters, but on CPMVs. As the non-translation parameters are refined, so each CPMVs may have a different offset in the refinement that is different from base MV refinement in which all the CPMVs have the same offset in the refinement. If the three initial CPMVs are denoted as CPMV0, CPMV1 and CPMV2, and the three refined CPMVs are denoted as CPMV0′, CPMV1′ and CPMV2′, their relations can be expressed in the following equations:

$${CPMV}^{′} = CPMV 0 + MV\_offset0$$

$$CPMV {1}^{′} = CPMV 1 + MV\_offset1$$

$$CPMV {2}^{′} = CPMV 2 + MV\_offset2$$

where MV_offset0, MV_offset1 and MV_offset2 are the three MV offsets searched in the TM refinement process for three CPMVs. For each search position, the sub-template MVs are derived according the CPMVs corresponding to the search position, and the TM cost is calculated accordingly. The CPMVs producing the minimum TM cost is treated as the refined CPMVs output by the TM refinement process.

All the search methods and the complexity reduction methods used in non-translation parameter search can be used in the CPMV search.

In some embodiments, optical based search can be used. To reduce the search complexity, optical flow-based search scheme is used in some embodiments. In this scheme, the next search position is calculated from the optical flow equation.

For an affine model

$$\{ \begin{matrix}{mv}_{x} = ax + by + {mv}_{0 x} \\ {mv}_{y} = cx + dy + {mv}_{0 y}\end{matrix} ,$$

the coefficient matrix can be constructed as

$$A = [ \begin{matrix}{G}_{x 0} & {x}_{0} {G}_{x 0} & {G}_{y 0} & {x}_{0} {G}_{y 0} & {y}_{0} {G}_{x 0} & {y}_{0} {G}_{y 0} \\ {G}_{x 1} & {x}_{1} {G}_{x 1} & {G}_{y 1} & {x}_{1} {G}_{y 1} & {y}_{1} {G}_{x 1} & {y}_{1} {G}_{y 1} \\ {G}_{x 2} & {x}_{2} {G}_{x 2} & {G}_{y 2} & {x}_{2} {G}_{y 2} & {y}_{2} {G}_{x 2} & {y}_{2} {G}_{y 2} \\ {G}_{x 3} & {x}_{3} {G}_{x 3} & {G}_{y 3} & {x}_{3} {G}_{y 3} & {y}_{3} {G}_{x 3} & {y}_{3} {G}_{y 3} \\ … & … & … & … & … & … \\ {G}_{xn} & {x}_{n} {G}_{xn} & {G}_{yn} & {x}_{n} {G}_{yn} & {y}_{n} {G}_{xn} & {x}_{n} {G}_{yn}\end{matrix} ]$$

where Gₓᵢ and G_{yi} is the horizontal and vertical gradient of the i-th sample in the template of the predicted block for a search position, (xᵢ, yᵢ) is the coordinate of the i-th sample in the template of the predicted block for the search position. Then the equation is constructed as

$$A X = R$$

where X is the vector of the affine model parameters and R is the residual vector of template samples. Thus, X and R are:

$$X = [ \begin{matrix}{mv}_{0 x} \\ a \\ {mv}_{0 y} \\ c \\ b \\ d\end{matrix} ] and R = [ \begin{matrix}{R}_{0} \\ {R}_{1} \\ {R}_{2} \\ {R}_{3} \\ … \\ {R}_{n}\end{matrix} ]$$

where Rᵢ is the difference of i-th sample in the template of the reference block and i-th sample in the template of the current block.

By solving the equation AX=R, we can get the solution X and X is the affine parameter for the next search position.

For each search position, we solve the equation to get the next position until it reaches a maximum number, or the next search position has already been searched before.

In some embodiments, template matching for bi-predicted affine block can be performed. Similar to non-affine coded block, for bi-prediction affine merge candidate, the refinement of the list 0 motion and list 1 motion can be performed iteratively.

First, the initial subblock MVs of two reference picture lists are derived based on the initial CPMVs, and then the list 0 template (which is the template of the reference block in the reference picture of list 0) and the list 1 template (which is the template of the reference block in the reference picture of list 1) are obtained from reference pictures by interpolation. Then the TMcost0 (which is the SAD or SATD between list 0 template and the current block template) and the TMcost1 (which is the SAD or SATD between list 1 template and the current block template) are calculated. If the TMcost0 is less than TMcost1, reference list 0 MV are fixed and list 1 motion is refined in the first step. If the TMcost0 is larger than TMcost1, reference list 1 motion is fixed and list 0 motion is refined in the first step.

In the template matching refinement for each list, the base MV refinement and the affine model (non-translation parameter) refinement can be applied. To refine list 0 motion, the base MV offset MV_offset searched and parameter offset offsetₐ, offset_b, offset_c, offset_d searched in the refinement process are for list 0. To refine list 1 motion, the base MV offset MV_offset searched and parameter offset offsetₐ, offset_b, offset_c, offset_d searched in the refinement process are for list 1.

After list i motion is refined, the list 1-i motion can be further refined. The same base MV refinement and affine model (non-translation parameters) refinement can be applied to list i-1 motion.

After list 1-i motion is refined, the list i motion can be further refined. The iteration can be performed to further refine the affine motion for two reference lists.

After the iterative bi-prediction affine motion refinement, the bi-prediction cost can also be compared with uni-prediction cost to determine whether convert the bi-predicted affine block into uni-predicted affine block.

In some embodiments, certain methods can be used to reduce the complexity of the affine non-translation parameter search. For example, the complexity reducing methods that can be applied in affine model search or CPMV search can also be used in the bi-predicted affine block template matching to reduce the complexity. In some embodiments, whether the template matching is performed on bi-predicted affine block is dependent on Quantization Parameter (QP). And if the template matching is performed on bi-predicted affine block, the iterative number is dependent on QP. Since QP controls the quantization in video coding and higher QP may introduce more coding errors, more refinement is needed in high QP case. Thus, to reduce the complexity and maintain the coding efficiency, the template matching is disabled for bi-predicted affine block in low QP case, and the iterative number is smaller in lower QP case and greater in higher QP case.

In some embodiments, whether the template matching is performed on bi-predicted affine block is dependent on the video sequence resolution. For example, for video sequences with high resolution, the template matching is disabled or the iterative number is set to a smaller value for longer sequences, and the template matching is enabled or the iterative number is set to a greater value for shorter sequences. Alternatively, for video sequences with low resolution, the template matching is disabled, or the iterative number is set to smaller value; and for high resolution, the template matching is enabled or the iterative umber is set to a greater value.

In some embodiments, whether the template matching is performed on bi-predicted affine block is dependent on the picture order count distance, and/or the temporal layer. For inter-coded frame, e.g., B frame and P frame, there is one or more reference frames. The time distance between the current frame and reference frame impacts the accuracy of the inter prediction. The time distance between two frames in video coding is usually represented by picture order count (POC) distance. Usually, with a longer POC distance, the inter prediction accuracy is lower and the motion information accuracy is also lower, and thus more refinement is needed. Thus, template-matching based refinement can be enabled in large POC distance case and disabled in short POC distance case. That is, if the POC distance between the current frame and the reference frame is larger than a threshold, the template-matching based refinement is used; and if the POC distance between the current frame and the reference frame is smaller than the threshold, the template-matching based refinement is disabled. As another example, the iterative number is larger in longer POC distance case and smaller in shorter POC distance case. That is, if the POC distance between the current frame and the reference frame is longer, the iterative number of bi-predicted affine block refinement is greater; and if the POC distance between the current frame the reference frame is shorter, the iterative number of bi-predicted affine block is smaller. For hierarchical B frame, a frame with a higher temporal layer has a shorter POC distance to the reference frame, and a frame with a lower temporal layer has a longer POC distance to the reference frame. Thus, whether to enable or disable template-matching based refinement on bi-predicted affine block may depend on the temporal layer of the current frame. For example, template-matching on bi-predicted affine block can be disabled for a high temporal layer, because the higher temporal layer has a shorter POC distance to the reference frame and may not need refinement; while template-matching on bi-predicted affine block can be enabled for a lower temporal layer, because the lower temporal layer has a longer POC distance to the reference frame and needs refinement. As another example, the iterative number of template-matching based refinement for bi-predicted affine block can be set to a smaller value for a higher temporal layer, and set to a greater value for a lower temporal layer. Consistent with the disclosed embodiments, other methods to reduce the complexity can be used for the higher temporal layer frame, and are not limited by the present disclosure.

In some embodiments, base MV refinement and affine model (non-translation parameter) refinement can be combined. The base MV refinement and affine model (i.e., affine non-translation parameter) refinement can be applied to an affine coded block at the same time.

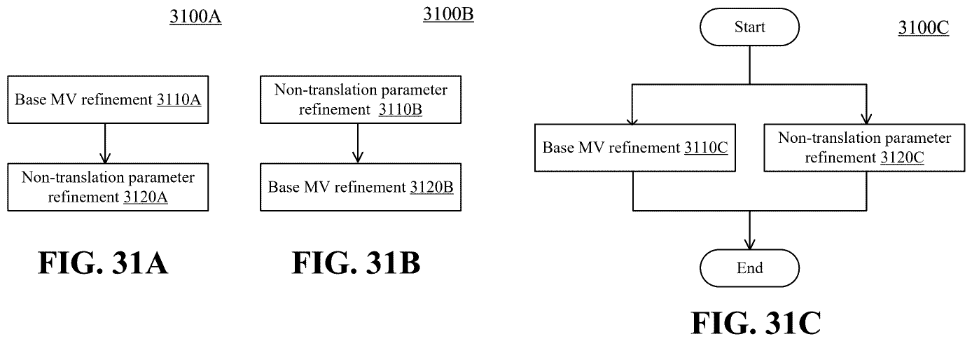

FIG. 31A and FIG. 31B are flowcharts illustrating processes 3100A and 3100B of performing base MV refinement and non-translation parameter refinement sequentially, according to some embodiments of the present disclosure. In some embodiments, the base MV refinement and affine non-translation parameter refinement are performed sequentially as in FIG. 31A and FIG. 31B. For example, as shown in FIG. 31A, in step 3110A, the base MV refinement operation can be performed first. After the refinement, in step 3120A, the refined base MV is fixed and then the affine non-translation parameter refinement operation is performed. In some other examples, as shown in FIG. 31B, in step 3110B, the non-translation parameter refinement operation is performed first, and the refinement, the refined parameters are fixed and then in step 3120B, the base MV refinement operation of the affine model is performed.

FIG. 31C is a flowchart illustrating a process 3100C of performing base MV refinement and non-translation parameter refinement parallelly, according to some embodiments of the present disclosure. In some embodiments, the base MV refinement and the affine non-translation parameter refinement are performed parallelly as shown in FIG. 31C. For example, in step 3110C, the base MV refinement is performed based on the initial affine motion to get refined base MV and the corresponding TM cost is costBaseMV, and in step 3120C, the non-translation parameter refinement is also performed based on the initial affine motion to get refined parameters and the corresponding TM cost is costParameter. If costBaseMV is less than or equal to costParameter, the result of the base MV refinement is used as the final motion for motion compensation. That is, the base MV of the affine model for the current block is refined and the parameters of the affine model for the current block are not refined. If costParameter is less than costBaseMV, the result of the non-translation parameter refinement is used as the final motion for motion compensation, That is, the base MV of the affine model for the current block is not refined but the non-translation parameters of the affine model for the current block is refined.

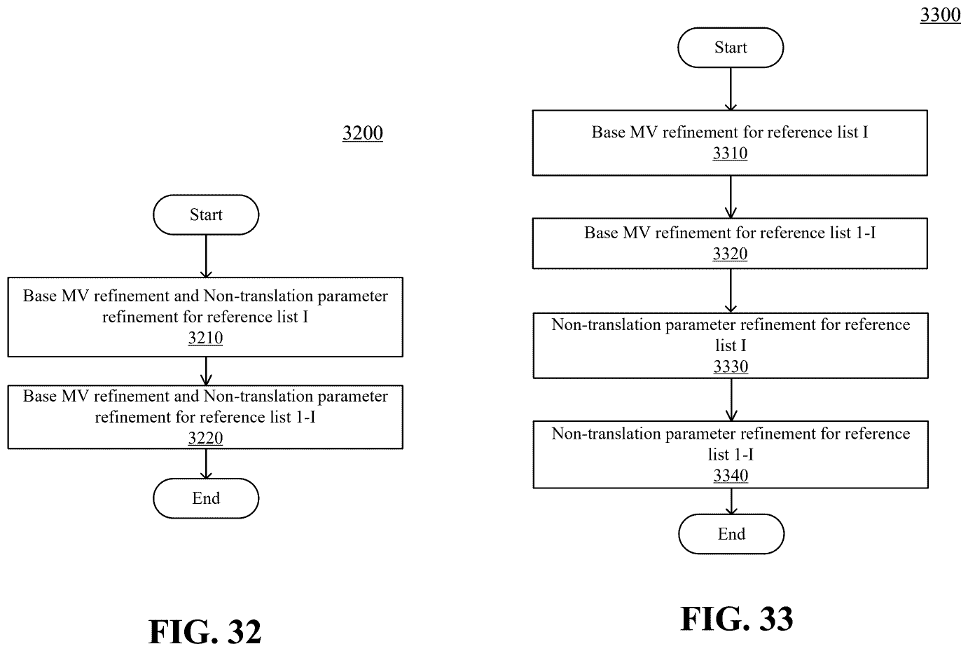

FIG. 32 is a flowchart illustrating a process 3200 of a refinement order of applying affine TM on a bi-prediction block, according to some embodiments of the present disclosure. When affine TM is applied on the bi-prediction block, the iterative refinement can be combined with the base MV refinement and non-translation parameter refinement. For example, shown as in FIG. 32, in step 3210, when list i motion is being refined, the base MV and non-translation parameter of affine model for list i are refined. After that, in step 3220, when list 1-i motion is being refined, the base MV and non-translation parameter of affine model for list 1-i are refined. FIG. 33 is a flowchart illustrating another process 3300 of a refinement order of applying affine TM on a bi-prediction block, according to some embodiments of the present disclosure. In some other examples, shown as in FIG. 33, base MV and non-translation parameter refinement are performed in two stages with different iterative processes. That is, the base MV is refined firstly in an iterative way, refining base MV of list i in step 3310, and then refining base MV list 1-i in step 3320. After that, non-translation parameters are refined in another iterative process, refining non-translation parameter of list i in step 3330, and then refining non-translation parameters of list 1-i in step 3340.

To reduce the complexity, in some embodiments, non-translation parameter refinement is not applied on bi-prediction block. That is, for uni-prediction affine block, both base MV refinement and non-translation parameter refinement are applied and for bi-prediction affine block, only base MV refinement is applied. In some other embodiments, non-translation parameter refinement is not applied on uni-prediction block. That is, for bi-prediction affine block, both base MV refinement and non-translation parameter refinement are applied and for uni-prediction affine block, only base MV refinement is applied. So, whether to apply affine TM is dependent on the prediction direction.

In some other embodiments, the TM cost obtained in the TM process is used to determine the skip or continue the following TM process. For example, in the case of base MV refinement and non-translation parameter refinement are performed sequentially, denote the TM cost of the initial motion as cost0 and TM cost after base MV refinement as cost1, if cost1<cost0 or cost1<k×cost0 where k is a factor less than 1, the non-translation parameter refinement is performed, otherwise the non-translation parameter refinement is skipped. The condition cost1<cost0 or cost1<k×cost0 means the base MV refinement does improve the affine motion for the current block, so TM maybe suitable for the current block and the non-translation is worth being performed. In another example, in the case of base MV refinement and non-translation parameter refinement are performed sequentially, denote the TM cost of the initial motion as cost0 and TM cost after base MV refinement as cost1, if cost1<h×cost0 where h is a factor less than 1, the non-translation parameter refinement is skipped, otherwise the non-translation parameter refinement is performed. The condition cost1<h×cost0 means the base MV refinement already improve the affine model significantly and thus the non-translation parameter refinement may not be needed.

After the base MV refinement and non-translation parameter refinement, the TM cost is denoted as costA and costA can be compared with the TM cost of initial motion cost0. And only if costA<h×cost0 where h is a factor less than 1, the refined affine motion is used for the motion compensation, otherwise the initial motion is used for the motion compensation.

In some embodiments, it is proposed to apply TM based motion refinement in affine AMVP mode. That is, for the AMVP candidate in the AMVP candidate list, the TM based refinement is applied to improve the accuracy of the motion, such that the value of MVD can be reduced and the signaling cost of MVD can be reduced.

The TM based motion refinement method used in the affine merge mode can also be used in affine AMVP mode.

As affine motion compensation is performed in subblock level, template of affine merge candidate also includes several sub-templates. If the template size used in TM is equal to Ts and the affine AMVP candidates with subblock size equal to Ws×Hs, the above template 2510 includes several sub-templates 5212-2518 with the size of Ws×Ts, and the left template 2520 includes several sub-templates 5222-2528 with the size of Ts×Hs which is as shown in FIG. 25, in which the white region is a current affine motion coded coding block 2530 including 16 subblocks and the shaded area is a template including 4 above sub-templates 5212-2518 with size of Ws×Ts and 4 left sub-templates 5222-2528 with size of Ts×Hs. Ts is the size of the template. For example, it could be 1, 2, 3 or 4.

For the template of the reference block, it also includes several sub-templates, each of which is the neighboring area of the boundary reference subblock. The template shown in FIG. 24, FIG. 26, or FIG. 27 may also be used for affine AMVP candidate refinement.

The TM cost is calculated as the SAD or SATD between the template of the reference block and the template of the current block. The existing search patterns, such as 3×3 square search as shown in FIG. 6, diamond search as shown in FIGS. 9A and 9B, search patterns as in FIG. 28A and FIG. 28B, may be used.

Similar as the TM based refinement applied in affine merge mode, when TM based refinement applied in affine AMVP mode, both base MV of the affine model and the non-translation parameters of the affine model can be refined. All the refinements method and the method to reduce the complexity descried in this disclosure can be applied.

After refinement, in the encoder side, the best candidate is selected from the AMVP candidate list. And then the selected CPMV predictor candidate is subtracted from the CPMVs which are determined by the motion estimation or other encoder algorithms. The CPMV differences are then encoded into the bitstream. As the AMVP candidate will impact the MVD, the encoder may jointly determine the best AMVP candidate and the CPMVs used in the motion compensation by rate-distortion optimization. In the decoder side, the decoder first constructs the AMVP candidate list, and then do TM based refinement on each AMVP candidate in the candidate list. After decoding the candidate index from the bitstream, the decoder can determine the candidate according to the candidate index. In an alternative way, the decode may first determine the AMVP candidate based on the candidate index decoded from the bitstream and then performs TM based refinement only on the AMVP candidate indicated by the candidate index. And then the CPMV differences which are decoded from the bitstream are added to the refined CPMV predictors to get the final value of the CPMVs and those CPMVs are used in the following decoding process.

To combine the TM based refinement and the ARMC on the AMVP mode, in one example, the ARMC is performed first. That is, the AMVP candidate list with N candidates are constructed. Then the TM based refinement is applied on the each of N candidates to get N refined candidates. Then the ARMC is performed to the N refined candidates and the first K (K<N) candidates are kept. The encoder then selects the best candidate from these K candidates in the AMVP candidate list and signal it the bitstream with the candidate index to the decoder. The decoder determines the selected candidate from these K refined candidate according to candidate index decoded from the bitstream. In this example, the TM based refinement is applied to the all the N candidates. To reduce the complexity, in another example, the ARMC is performed before the TM based refinement. That is, the AMVP candidate list with N candidates are constructed. Then the ARMC is performed, and the first K (K<N) candidate are kept in the AMVP candidate list. After it, TM based refinement is applied on the each of K candidates to get K refined candidates. The encoder then selects the best candidate from these refined K candidates in the AMVP candidate list and signal it the bitstream with the candidate index to the decoder. The decoder determines the selected candidate from these K refined candidate according to candidate index decoded from the bitstream. In this example, the TM based refinement is applied K times to the K candidates. As K is less than N, so less refinement is performed in the second example. When K is equal to 1, the signaling of the candidate index can be skipped. To further reduce the complexity, the decoder may perform the TM based refinement after selecting the candidate from the K candidates. That is, the decoder constructs the candidate list with N candidates and perform ARMC. After reordering, only the first K (K<N) candidates are kept. Then, the decoder determines the selected candidate among the K candidates based on the candidate index decoded from the bitstream. And then the TM based refinement is only applied to the selected candidate to the refined AMVP predictor. In this case, the decoder only needs to perform TM based refinement once.

In some embodiments, high-level control flag(s) can be used for template-based refinement. For example, to control the template-matching based refinement, a control flag can be signaled in a sequence parameter set (SPS). The value of the flag can be set by the encoder and signaled to the decoder, to indicate whether TM based refinement is enabled or disabled. When the flag is equal to 1, the TM is enabled for the sequence; and when the flag is equal to 0, the TM is disabled for the sequence. The encoder has the flexibility to set the value of the flag. For example, to use the method to reduce the complexity, the encoder may set the value to 0 in low QP case and set the flag to 1 in high QP case. Consistent with the disclosed embodiments, the encoder may set the flag in other ways, and the present disclosure does not limit the specific ways of setting the flag values.

In some embodiments, there can be multiple control flags in SPS to control template-matching based refinement. For example, a first SPS flag can be used to control template-matching based refinement for conventional inter-prediction block, a second SPS flag can be used to control template-matching based refinement for affine parameter of a affine coded block, a third SPS flag can be used to control template-matching based refinement for bi-predicted affine block, and/or a fourth SPS flag can be used to control template-matching based refinement for subblock temporal motion prediction (SBTMVP) block.

In some embodiments, to have a finer control granularity, another control flag can be signaled in the picture parameter set (PPS) to control template-matching based refinement in picture level. Thus, different frames within one sequence may have different choices. TM can be enabled on some frames and disabled on the other frames. Similar with the control flag(s) in SPS, multiple PPS control flags can be used for TM based refinement. For example, a first PPS flag can be used to control template-matching based refinement for conventional inter-prediction block, a second PPS flag can be used to control template-matching based refinement for affine parameter of a affine coded block, a third PPS flag can be used to control template-matching based refinement for bi-predicted affine block, and/or a fourth PPS flag can be used to control template-matching based refinement for subblock temporal motion prediction (SBTMVP) block.

There can be separated control flags for TM based refinement on affine merge mode and on affine AMVP mode. There also can be a shared flag for both TM based refinement on affine merge mode and on affine AMVP mode.

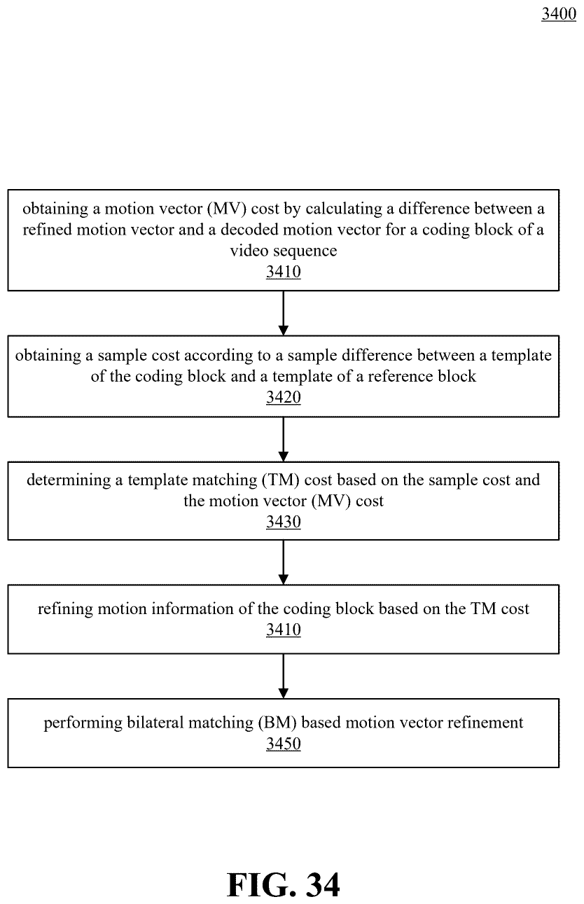

FIG. 34 is a flowchart of an example video decoding method 3400, according to some embodiments of the present disclosure. In some embodiments, the video decoding method 3400 can be performed by a decoder (e.g., decoder 300 in FIG. 3). For example, the decoder can be implemented as one or more software or hardware components of an apparatus (e.g., apparatus 400 in FIG. 4) for decoding the bitstream (e.g., video bitstream 228 in FIG. 3) to reconstruct a video frame or a video sequence (e.g., video stream 304 in FIG. 3) of the bitstream. For example, a processor (e.g., processor 402 in FIG. 4) can perform the video decoding method 3400. As shown in FIG. 34, the method 3400 may include steps 3410-3450.

Referring to the video decoding method 3400, at step 3410, the decoder obtains a motion vector (MV) cost by calculating a difference between a refined motion vector and a decoded motion vector for a coding block of a video sequence (e.g., video stream 304 in FIG. 3).

At step 3420, the decoder obtains a sample cost according to a sample difference between a template of the coding block and a template of a reference block.

At step 3430, the decoder determines a template matching (TM) cost based on the sample cost and the motion vector (MV) cost.

At step 3440, the decoder performs a TM based refinement and refines motion information of the coding block based on the TM cost.

In some embodiments, the video decoding method 3400 further includes step 3450. At step 3450, after refining the motion information of the coding block based on the TM cost, the decoder performs bilateral matching (BM) based motion vector refinement.

In some embodiments, the video decoding method 3400 further includes steps for performing a multi-pass motion vector refinement. Operations of the multi-pass motion vector refinement include applying a block level bilateral matching MV refinement, applying a subblock level bilateral matching MV refinement, and applying a subblock level bi-directional optical flow MV refinement. For example, as illustrated in FIG. 23A, the decoder may perform step 3440 before applying the block level bilateral matching MV refinement. For example, as illustrated in FIG. 23B, the decoder may perform step 3440 after applying the subblock level bilateral matching MV refinement and before applying the subblock level bi-directional optical flow MV refinement.

In some embodiments, the video decoding method 3400 further includes steps for converting a bi-prediction coding block into a uni-prediction block according to the TM cost determined. For example, the decoder may, in response to the coding block being a bi-prediction coding block, compare a bi-prediction TM cost with a smaller one of two uni-prediction TM costs, and convert the coding block to a uni-prediction block in response to a comparison result based on the bi-prediction TM cost and the smaller one of the two uni-prediction TM costs.

In some embodiments, the video decoding method 3400 further includes steps for template-based reordering of merge candidate. For example, as illustrated in FIG. 29, the decoder may construct an initial candidate list including candidates, reorder the candidates in the initial candidate list, and refine the reordered candidates by template matching based refinement. The initial candidate list may be a merge candidate list for a regular merge mode, TM merge mode, or affine merge mode, or an advanced motion vector prediction (AMVP) candidate list for an affine AMVP mode.

In some embodiments, the video decoding method 3400 further includes steps for performing a base MV refinement and an affine non-translation parameter refinement. For example, as illustrated in FIGS. 31A-31C, the base MV refinement and the affine non-translation parameter refinement can be performed sequentially or in parallel.

In some embodiments, the video decoding method 3400 further includes a step of determining whether to enable or disable TM based refinement for the video sequence according to a control flag in a sequence parameter set (SPS) or a picture parameter set (PPS) of the video sequence. As discussed above, the value of the flag can be set by the encoder and signaled to the decoder, to indicate whether TM based refinement is enabled or disabled. In some embodiments, there can be multiple control flags in SPS to control template-matching based refinement.

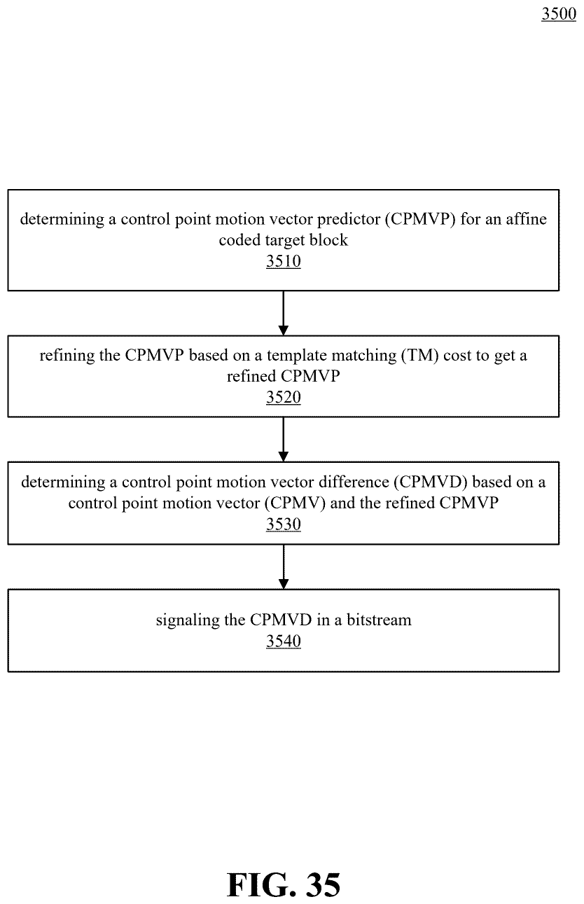

FIG. 35 is a flowchart for an example method 3500 for encoding a video bitstream, according to some embodiments of the present disclosure. The method 3500 can be performed by an encoder (e.g., encoder 200 in FIG. 2) to encode a video bitstream. For example, the encoder can be implemented as one or more software or hardware components of an apparatus (e.g., apparatus 400 in FIG. 4) for encoding the bitstream (e.g., video bitstream 228 in FIG. 2) for reconstructing a video frame or a video sequence. For example, a processor (e.g., processor 402 in FIG. 4) can perform the method 3500. As shown in FIG. 35, the method 3500 includes the following steps 3510-3540.

At step 3510, the encoder determines a control point motion vector predictor (CPMVP) for an affine coded target block. At step 3520, the encoder refines the CPMVP based on a template matching (TM) cost to get a refined CPMVP. For example, at step 3520, the encoder may derive a motion vector offset by minimizing the TM cost, and derive the refined CPMVP by adding the motion vector offset to the CPMVP. In some embodiments, step 3520 includes the operations of determining at least one non-translational affine parameter based on the CPMVP, refining the at least one non-translational affine parameter to respectively get at least one refined non-translational affine parameter, and deriving the refined CPMVP based on the refined non-translation affine parameter. For example, the encoder may derive a non-translational parameter offset by minimizing the TM cost, and derive the refined non-translational affine parameter by adding the non-translational parameter offset to the non-translational parameter.

In some embodiments, step 3520 includes the operations of determining first motion vectors based on the CPMVP, determining a first template from a reference picture based on the plurality of first motion vectors, and calculating the TM cost based on a sample difference between the first template and a second template. For example, the encoder may divide the target block into subblocks, derive second motion vectors associated with the subblocks respectively based on the CPMVP, and determine the first motion vectors based on the second motion vectors. For example, the encoder may determine the first motion vectors to be respectively equal to the second motion vectors

In some embodiments, the subblocks include left boundary subblocks and top boundary subblocks of the target block, and the encoder determines the second motion vectors associated with at least one of the left boundary subblocks or the top boundary subblocks.

In some embodiments, the encoder may determine the first motion vectors based on the CPMVP by determining the first motion vectors by invoking an affine model.

In some embodiments, the second template includes N top neighboring rows or M left neighboring columns of the target block, M and N being integers.

At step 3530, the encoder determines a control point motion vector difference (CPMVD) based on a control point motion vector (CPMV) and the refined CPMVP. At step 3540, the encoder signals the CPMVD in a bitstream (e.g., video bitstream 228 in FIG. 2). The operations of the TM based refinement are discussed above in detail in the embodiments of the present disclosure, and thus are not repeated herein for the sake of brevity.

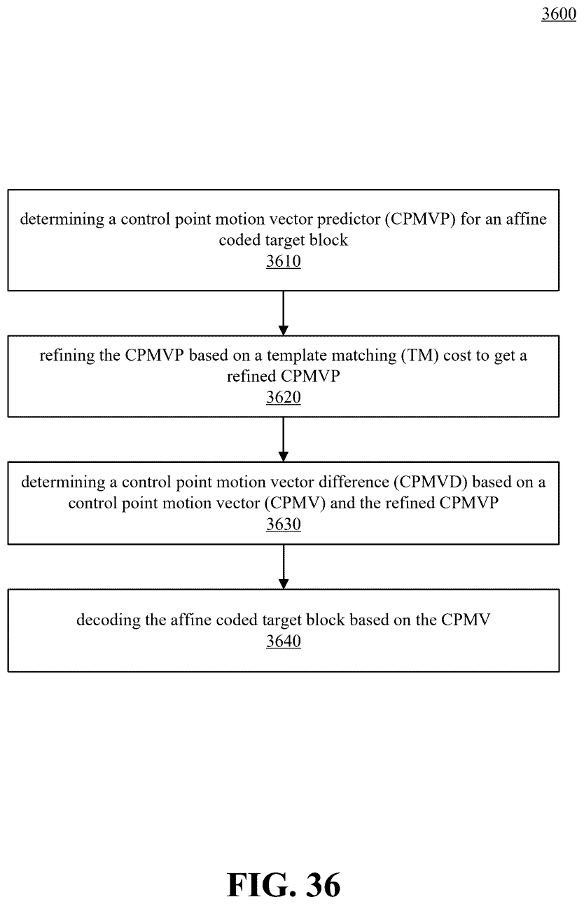

FIG. 36 is a flowchart for an example method 3600 for decoding a video bitstream, according to some embodiments of the present disclosure. In some embodiments, the method 3600 can be performed by a decoder (e.g., decoder 300 in FIG. 3). For example, the decoder can be implemented as one or more software or hardware components of an apparatus (e.g., apparatus 400 in FIG. 4) for decoding the bitstream (e.g., video bitstream 228 in FIG. 3) to reconstruct a video frame or a video sequence (e.g., video stream 304 in FIG. 3) of the bitstream. For example, a processor (e.g., processor 402 in FIG. 4) can perform the method 3600. As shown in FIG. 36, the method 3600 may include steps 3610-3640.

At step 3610, the decoder determines a control point motion vector predictor (CPMVP) for an affine coded target block. At step 3620, the decoder refines the CPMVP based on a template matching (TM) cost to get a refined CPMVP. At step 3630, the decoder determines a control point motion vector difference (CPMVD) based on a control point motion vector (CPMV) and the refined CPMVP. At step 3640, the decoder decodes the affine coded target block based on the CPMV. Detailed operations of the TM based refinement in steps 3610-3630 are the same or similar to those of steps 3510-3530 in FIG. 35 discussed above, and thus are not repeated herein for the sake of brevity.

The embodiments described in the present disclosure can be freely combined.

In some embodiments, a non-transitory computer-readable storage medium storing a bitstream is also provided. The bitstream can be encoded and decoded according to the disclosed TM-based motion refinement methods. For example, a method for transmitting a bitstream may include receiving a video sequence, encoding the video sequence by the method 3500 in FIG. 35, and signaling a bitstream including the CPMVD generated based on the encoding.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

The embodiments may further be described using the following clauses:
1. A method of decoding a video bitstream, comprising:
determining a control point motion vector predictor (CPMVP) for an affine coded target block;
refining the CPMVP based on a template matching (TM) cost to get a refined CPMVP;
deriving a control point motion vector (CPMV) based on the refined CPMVP and a control point motion vector difference (CPMVD); and
decoding the affine coded target block based on the CPMV.
2. The method according to clause 1, wherein refining the CPMVP based on template matching to get the refined CPMVP comprises:
determining a plurality of first motion vectors based on the CPMVP;
determining a first template from a reference picture based on the plurality of first motion vectors; and
calculating the TM cost based on a sample difference between the first template and a second template.
3. The method according to clause 2, further comprises:
dividing the target block into a plurality of subblocks;
deriving a plurality of second motion vectors associated with the plurality of subblocks respectively based on the CPMVP; and
determining the plurality of first motion vectors based on the plurality of second motion vectors.
4. The method according to clause 3, wherein the plurality of subblocks comprise left boundary subblocks and top boundary subblocks of the target block, and deriving the plurality of second motion vectors associated with the plurality of subblocks respectively based on CPMVP comprises:
determining the plurality of second motion vectors associated with at least one of the left boundary subblocks or the top boundary subblocks.
5. The method according to clause 3 or 4, wherein determining the plurality of first motion vectors based on the plurality of second motion vectors comprises:
determining the plurality of first motion vectors to be respectively equal to the plurality of second motion vectors.
6. The method according to any of clauses 2-5, wherein determining the plurality of first motion vectors based on the CPMVP comprises:
determining the plurality of first motion vectors by invoking an affine model.
7. The method according to any of clauses 2-6, wherein the second template comprises N top neighboring rows or M left neighboring columns of the target block, M and N being integers.
8. The method according to any of clauses 1-7, wherein refining the CPMVP based on the template matching (TM) cost to get the refined CPMVP comprises:
deriving a motion vector offset by minimizing the TM cost; and deriving the refined CPMVP by adding the motion vector offset to the CPMVP.
9. The method according to any of clauses 1-8, wherein refining the CPMVP based on the template matching (TM) cost to get the refined CPMVP comprises:
determining at least one non-translational affine parameter based on the CPMVP;
refining the at least one non-translational affine parameter to respectively get at least one refined non-translational affine parameter; and
deriving the refined CPMVP based on the refined non-translation affine parameter.
10. The method according to clause 9, wherein refining the at least one non-translational affine parameter to respectively get the at least one refined non-translational affine parameter comprises:
deriving a non-translational parameter offset by minimizing the TM cost; and
deriving the refined non-translational affine parameter by adding the non-translational parameter offset to the non-translational parameter.
11. A method of encoding a video bitstream, comprising:
determining a control point motion vector predictor (CPMVP) for an affine coded target block;
refining the CPMVP based on a template matching (TM) cost to get a refined CPMVP;
determining a control point motion vector difference (CPMVD) based on a control point motion vector (CPMV) and the refined CPMVP; and
signaling the CPMVD in a bitstream.
12. The method according to clause 11, wherein refining the CPMVP based on template matching to get the refined CPMVP comprises:
determining a plurality of first motion vectors based on the CPMVP;
determining a first template from a reference picture based on the plurality of first motion vectors; and
calculating the TM cost based on a sample difference between the first template and a second template.
13. The method according to clause 12, further comprising:
dividing the target block into a plurality of subblocks;
deriving a plurality of second motion vectors associated with the plurality of subblocks respectively based on the CPMVP; and
determining the plurality of first motion vectors based on the plurality of second motion vectors.

14. The method according to clause 13, wherein the plurality of subblocks comprise left boundary subblocks and top boundary subblocks of the target block, and deriving the plurality of second motion vectors associated with the plurality of subblocks respectively based on CPMVP comprises:
determining the plurality of second motion vectors associated with at least one of the left boundary subblocks or the top boundary subblocks.
15. The method according to clause 13 or 14, wherein determining the plurality of first motion vectors based on the plurality of second motion vectors comprises:
determining the plurality of first motion vectors to be respectively equal to the plurality of second motion vectors.
16. The method according to any of clauses 12-15, wherein determining the plurality of first motion vectors based on the CPMVP comprises:
determining the plurality of first motion vectors by invoking an affine model.
17. The method according to any of clauses 12-16, wherein the second template comprises N top neighboring rows or M left neighboring columns of the target block, M and N being integers.
18. The method according to any of clauses 11-17, wherein refining the CPMVP based on the template matching (TM) cost to get the refined CPMVP comprises:
deriving a motion vector offset by minimizing the TM cost; and
deriving the refined CPMVP by adding the motion vector offset to the CPMVP.
19. The method according to any of clauses 11-18, wherein refining the CPMVP based on the template matching (TM) cost to get the refined CPMVP comprises:
determining at least one non-translational affine parameter based on the CPMVP;
refining the at least one non-translational affine parameter to respectively get at least one refined non-translational affine parameter; and
deriving the refined CPMVP based on the refined non-translation affine parameter.
20. A method for transmitting a bitstream, comprising:
receiving a video sequence;
encoding the video sequence by:
   determining a control point motion vector predictor (CPMVP) for an affine coded target block;
   refining the CPMVP based on a template matching (TM) cost to get a refined CPMVP; and
   determining a control point motion vector difference (CPMVD) based on a control point motion vector (CPMV) and the refined CPMVP; and signaling a bitstream comprising the CPMVD generated based on the encoding.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method of decoding a video bitstream, comprising:
determining a control point motion vector predictor (CPMVP) for an affine coded target block;
refining the CPMVP based on a template matching (TM) cost to get a refined CPMVP;
deriving a control point motion vector (CPMV) based on the refined CPMVP and a control point motion vector difference (CPMVD); and
decoding the affine coded target block based on the CPMV.

2. The method according to claim 1, wherein refining the CPMVP based on template matching to get the refined CPMVP comprises:
determining a plurality of first motion vectors based on the CPMVP;
determining a first template from a reference picture based on the plurality of first motion vectors; and
calculating the TM cost based on a sample difference between the first template and a second template.

3. The method according to claim 2, further comprises:
dividing the target block into a plurality of subblocks;
deriving a plurality of second motion vectors associated with the plurality of subblocks respectively based on the CPMVP; and
determining the plurality of first motion vectors based on the plurality of second motion vectors.

4. The method according to claim 3, wherein the plurality of subblocks comprise left boundary subblocks and top boundary subblocks of the target block, and deriving the plurality of second motion vectors associated with the plurality of subblocks respectively based on CPMVP comprises:
determining the plurality of second motion vectors associated with at least one of the left boundary subblocks or the top boundary subblocks.

5. The method according to claim 3, wherein determining the plurality of first motion vectors based on the plurality of second motion vectors comprises:
determining the plurality of first motion vectors to be respectively equal to the plurality of second motion vectors.

6. The method according to claim 2, wherein determining the plurality of first motion vectors based on the CPMVP comprises:
determining the plurality of first motion vectors by invoking an affine model.

7. The method according to claim 2, wherein the second template comprises N top neighboring rows or M left neighboring columns of the target block, M and N being integers.

8. The method according to claim 1, wherein refining the CPMVP based on the template matching (TM) cost to get the refined CPMVP comprises:
deriving a motion vector offset by minimizing the TM cost; and
deriving the refined CPMVP by adding the motion vector offset to the CPMVP.

9. The method according to claim 1, wherein refining the CPMVP based on the template matching (TM) cost to get the refined CPMVP comprises:
determining at least one non-translational affine parameter based on the CPMVP;
refining the at least one non-translational affine parameter to respectively get at least one refined non-translational affine parameter; and
deriving the refined CPMVP based on the refined non-translation affine parameter.

10. The method according to claim 9, wherein refining the at least one non-translational affine parameter to respectively get the at least one refined non-translational affine parameter comprises:
deriving a non-translational parameter offset by minimizing the TM cost; and
deriving the refined non-translational affine parameter by adding the non-translational parameter offset to the non-translational parameter.

11. A method of encoding a video bitstream, comprising:
determining a control point motion vector predictor (CPMVP) for an affine coded target block;
refining the CPMVP based on a template matching (TM) cost to get a refined CPMVP;
determining a control point motion vector difference (CPMVD) based on a control point motion vector (CPMV) and the refined CPMVP; and
setting the CPMVD in a bitstream.

12. The method according to claim 11, wherein refining the CPMVP based on template matching to get the refined CPMVP comprises:
determining a plurality of first motion vectors based on the CPMVP;
determining a first template from a reference picture based on the plurality of first motion vectors; and
calculating the TM cost based on a sample difference between the first template and a second template.

13. The method according to claim 12, further comprising:
dividing the target block into a plurality of subblocks;
deriving a plurality of second motion vectors associated with the plurality of subblocks respectively based on the CPMVP; and
determining the plurality of first motion vectors based on the plurality of second motion vectors.

14. The method according to claim 13, wherein the plurality of subblocks comprise left boundary subblocks and top boundary subblocks of the target block, and deriving the plurality of second motion vectors associated with the plurality of subblocks respectively based on CPMVP comprises:
determining the plurality of second motion vectors associated with at least one of the left boundary subblocks or the top boundary subblocks.

15. The method according to claim 13, wherein determining the plurality of first motion vectors based on the plurality of second motion vectors comprises:
determining the plurality of first motion vectors to be respectively equal to the plurality of second motion vectors.

16. The method according to claim 12, wherein determining the plurality of first motion vectors based on the CPMVP comprises:
determining the plurality of first motion vectors by invoking an affine model.

17. The method according to claim 12, wherein the second template comprises N top neighboring rows or M left neighboring columns of the target block, M and N being integers.

18. The method according to claim 11, wherein refining the CPMVP based on the template matching (TM) cost to get the refined CPMVP comprises:
deriving a motion vector offset by minimizing the TM cost; and
deriving the refined CPMVP by adding the motion vector offset to the CPMVP.

19. The method according to claim 11, wherein refining the CPMVP based on the template matching (TM) cost to get the refined CPMVP comprises:
determining at least one non-translational affine parameter based on the CPMVP;
refining the at least one non-translational affine parameter to respectively get at least one refined non-translational affine parameter; and
deriving the refined CPMVP based on the refined non-translation affine parameter.

20. A method for transmitting a bitstream, comprising:
receiving a video sequence;
encoding the video sequence by:
determining a control point motion vector predictor (CPMVP) for an affine coded target block;
refining the CPMVP based on a template matching (TM) cost to get a refined CPMVP; and
determining a control point motion vector difference (CPMVD) based on a control point motion vector (CPMV) and the refined CPMVP; and
signaling a bitstream comprising the CPMVD generated based on the encoding.
